(19) United States
(12) Patent Application Publication
(10) Pub. No.: US 2025/0316022 A1
(43) Pub. Date: Oct. 9, 2025

(54) GENERATING VECTOR DRAWINGS BASED ON A THREE DIMENSIONAL REPRESENTATION OF A PHYSICAL SCENE AT A LOCATION

(71) Applicant: YEMBO, INC., San Diego, CA (US)

(72) Inventors: Kyle BABINOWICH, San Diego, CA (US); Maciej HALBER, San Diego, CA (US); Zachary RATTNER, San Diego, CA (US); Hailey HANSARD, San Diego, CA (US); Krista BABINOWICH, San Diego, CA (US)

(21) Appl. No.: 19/169,356

(22) Filed: Apr. 3, 2025

Related U.S. Application Data
(60) Provisional application No. 63/574,002, filed on Apr. 3, 2024.

(51) Int. Cl. G06T 17/00; G06T 11/60; G06T 15/00

(52) U.S. Cl. CPC G06T 17/00; G06T 11/60; G06T 15/00

(57) ABSTRACT

The described systems and methods are configured generate a 3D virtual representation of a physical scene at a location, and output isometric and/or orthographic vector drawings based on the 3D virtual representation. The vector drawings are generated by rendering views of the 3D virtual representation in a scalable vector graphics (SVG) format, so that the views can be zoomed without blurring or other decreases in image viewability. Further, sub-rooms, tags, labels, and/or dimensions may be added to the output. Rather than taking hours to generate drawings, the described systems and methods enable generation in a few milliseconds, among other advantages.

### CROSS REFERENCE TO RELATED APPLICATION(S)

This disclosure claims priority to U.S. Provisional Patent Application No. 63/574,002, filed Apr. 3, 2024, all contents of which are herein incorporated by reference in their entirety.

### FIELD OF THE DISCLOSURE

This disclosure relates to generating vector drawings based on a three dimensional representation of a physical scene at a location.

### BACKGROUND

Various tasks for home services revolve around an accurate three-dimensional spatial and semantic understanding of a location such as a home. For example, planning renovations requires understanding the current state and dimensions of the home. Filing an insurance claim requires accurate documentation and measurements of structures and/or corresponding damages. Moving into a new home requires a reliable estimate as to whether one's belongings and furniture will fit, for example. Currently, achieving the requisite three-dimensional spatial and semantic understanding involves manual measurements, hard-to-acquire architectural drawings, and/or arrangements with multiple parties with competing schedules and interests.

A simplified and more user friendly system for capturing images and videos of a location, generating accurate virtual representations based on the captured images and videos, and generating accurate and scalable architectural drawings based on the virtual representations is needed. For example, a system that can use the images and videos to automatically generate a virtual representation and corresponding architectural drawings is desired. Further, means for interacting with the virtual representation and/or architectural drawings are needed to enable the user to easily extract, or modify desired information about the location or items at the location.

### SUMMARY

The described systems and methods are configured generate a three dimensional (3D) representation of a physical scene at a location, and output isometric and/or orthographic vector drawings based on the 3D representation. The 3D representation is an electronic virtual representation. The vector drawings are generated by rendering views of the 3D representation in a scalable vector graphics (SVG) format, so that the views can be zoomed without blurring or other decreases in image viewability. Normally drawings like these might require hours to generate. Using the described systems and methods, these drawings can be generated in a few milliseconds.

A non-transitory computer readable medium having instructions thereon is provided. The instructions are configured to cause a computer to perform operations comprising receiving description data of a physical scene at a location, and generating, with a trained machine learning model, a three dimensional representation of the physical scene based on the description data. The three dimensional representation comprising data items corresponding to surfaces and/or contents in the physical scene. The operations further comprise generating one or more isometric and/or orthographic vector drawings of the surfaces and/or contents in the physical scene based on the three dimensional representation.

In some embodiments, the one or more isometric and/or orthographic vector drawings are generated using a scalable vector graphics (SVG) two dimensional file format. In some embodiments, generating the one or more isometric and/or orthographic vector drawings comprises sorting the data items based on their locations in the three dimensional representation of the physical scene at the location, and rendering the one or more isometric and/or orthographic vector drawings back to front, starting with surfaces and/or contents that are farthest from a view location for the one or more isometric and/or orthographic vector drawings. In some embodiments, generating the one or more isometric and/or orthographic vector drawings using SVG, back to front in the physical scene at the location, facilitates infinite scaling of the one or more isometric and/or orthographic vector drawings without appreciable without appreciable blurring.

In some embodiments, the one or more isometric and/or orthographic vector drawings are generated in real time responsive to the computer receiving user input requesting generation.

In some embodiments, the surfaces and/or contents in the physical scene comprise walls, a ceiling, a floor, a window, a door, a wall opening, a support column, a household appliance, a countertop, a cabinet, a permanent fixture, a staircase, a toilet, a bathtub, a fireplace, the type of flooring, and/or other items.

In some embodiments, the one or more isometric and/or orthographic vector drawings depict one or more of: a multiroom, stitched floor plan component, and/or sub-rooms, such as closets, which have a “parent-child” room association. In embodiments, sub-rooms may have walled or unwalled components.

In some embodiments, the one or more isometric and/or orthographic vector drawings of the surfaces and/or contents in the physical scene comprise a three dimensional summary view, a two dimensional floorplan, and/or a wall detail view. Generating the three dimensional summary view may comprise extracting key data items comprising walls, windows, and/or doors from the three dimensional representation of the physical scene, projecting the three dimensional representation in an isometric view, and rendering the three dimensional summary view using a scalable vector graphics (SVG) two dimensional file format based on the projecting. Generating the two dimensional floorplan may comprise extracting the key data items, projecting the three dimensional representation in a top down view, and rendering the two dimensional floorplan using the SVG two dimensional file format based on the projecting. Generating the wall detail view may comprise extracting the key data items, positioning a camera view of the three dimensional representation looking at a wall of interest, and generating and rendering the wall detail view using the SVG two dimensional file format based on the camera view for output.

In some embodiments, the description data comprises one or more images of the physical scene, and the one or more images are generated via a camera associated with a user. In some embodiments, the description data is generated via at least one of a camera, a user interface, an environment sensor, and an external location information database, and the description data comprises one or more images of the physical scene. In some embodiments, the description data comprises one or more media types. The one or more media types may comprise at least one or more of video data, image data, audio data, text data, user interface/display data, and/or sensor data. In some embodiments, receiving description data comprises receiving one or more images from a camera and/or sensor data from one or more environment sensors. The one or more environment sensors may comprise at least one of a GPS, an accelerometer, a gyroscope, a barometer, a microphone, and/or other sensors.

In some embodiments, the three dimensional representation comprises a textured or untextured three-dimensional mesh with vertices connected by edges, defining triangular or quadrilateral planar faces. A texture map may comprise position, surface normal, and/or other information associated with the vertices, faces, and/or other components of the three dimensional representation. The vertices may be thought of like stars and polygons (the “constellations”) can be represented and labeled as different items. For example, a rectangular door would be represented as a set of 4 vertices in x/y/z coordinate space. In some embodiments, the three dimensional representation of the physical scene is stored as a triangle mesh, which comprises a graph data structure storing lists of vertices and a list of indices that indicate which vertices are joined together as a triangle, with each vertex comprising attributes including a position, a color, a normal vector, a parametrization coordinate, an instance index and a semantic class index. Generating the three dimensional representation of the physical scene based on the description data may comprise transferring detections of physical scene structures indicated by the data items to the three dimensional representation by: predicting, with the trained machine learning model, semantic classes for two dimensional input video frames included in the description data, projecting mesh vertices onto a camera image plane to map each of the mesh's vertices to image coordinates and determine a predicted label; determining whether a projected mesh vertex falls into a region labeled as a floor, wall, or ceiling; and determining a per mesh triangle label, where a triangle is labeled as part of the floor, wall, or ceiling if all of its adjacent vertices are labeled as floor, wall, or ceiling.

In some embodiments, the operations comprise extracting the data items by providing the description data as input to the trained machine learning model to identify the data items. The trained machine learning model may comprise a convolutional neural network (CNN) and may be trained to identify objects and structures in multiple physical scenes as the data items. The machine learning model is trained with training data. The training data comprises input output training pairs associated with each potential data item.

In some embodiments, the machine learning model is trained by obtaining physical scene data associated with a specified physical scene at the location. The physical scene data may include an image, a video or a three dimensional digital model associated with the specified physical scene. The machine learning model is trained with the physical scene data to predict a specified set of surfaces and/or contents in the specified physical scene such that a cost function that is indicative of a difference between a reference set of surfaces and/or contents and the specified set of contents is minimized. The trained machine learning model may be configured to predict spatial localization data of the data items and/or make other predictions. The spatial localization data corresponds to location information of the surfaces and/or contents in the physical scene, and/or other information.

In some embodiments, the operations comprise determining the attributes of the data items with the trained machine learning model. The attributes may comprise dimensions and/or locations of the surfaces and/or contents, for example.

For example, in embodiments, attributes of the data items refers to architectural annotations that are generated for the surfaces and/or contents of the generated one or more isometric and/or orthographic vector drawings. According to an embodiment, the generated architectural annotations may include one or more of: a label, identification tags, and dimensions. In some embodiments, the generated one or more isometric and/or orthographic vector drawings are rendered with the generated architectural annotations based on a drawing scale of the drawings generated using the scalable vector graphics (SVG) two dimensional file format. In embodiments, architectural annotations for each of the extracted key data items may be generated, and the rendered three dimensional summary view may be updated with the generated architectural annotations.

According to some embodiments, the attributes/generated architectural annotations includes dimensions, and the dimensions are configured to be rendered in a hierarchy with at least two tiers comprising inner tiers and an outer tiers. Such tiers may indicate, for example, each window, door, and/or opening within the walls in one tier, and at least an overall length of each wall segment of walls in another tier. Rules or guidelines regarding addition or use of tiers may be considered, in accordance with embodiments.

According to some embodiments, the attributes/generated architectural annotations further includes tags, and the dimensions are configured to be offset by a predetermined measurement range from wall outlines of the walls. Tags for the walls may be rendered outside of the dimensions and/or wall elevations, for example.

In embodiments, attributes of the data items refers to architectural annotations that are generated for each of the extracted key data items, and isometric projections of interior rooms are generated as part of the drawings. In some embodiments, the generated architectural annotations may include one or more of: a label, identification tags, and dimensions. In some embodiments, a rendered two dimensional floorplan is updated with the generated architectural annotations. Also, in embodiments, edges and lines of varying line-weight and/or opacity may be rendered on such drawings to provide depth, for example. In some embodiments, generated architectural annotations may include dynamic tags that maintain consistent sizing with scaled floor plans and wall elevations of the two dimensional floorplan. Tags for the walls, windows, and/or doors may be rendered relative to a predefined center-point on the extracted key data items.

In some embodiments, the operations comprise determining point to point measurements in the three dimensional representation, determining area measurements of one or more data items, and/or receiving user annotations related to one or more of the data items, and generating the one or more isometric and/or orthographic vector drawings based on the point to point measurements, the area measurements, and/or the user annotations. Similarly, in embodiments, operations include determining perimeter measurements, which may include point to point measurements, and generating the one or more isometric and/or orthographic vector drawings based on the same.

According to other embodiments, systems and/or methods configured to perform the operations described above are also provided. It should also be understood that any of the methods and/or steps performed by the system as disclosed herein may be utilized as algorithms configured to process the received data and output the disclosed generations and/or renderings.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a system for generating vector drawings based on a 3D representation of a location, in accordance with one or more embodiments.

FIG. 2 illustrates an artificial intelligence (AI) (e.g., one or more electronic machine learning models) machine learning model and/or framework that may be trained to generate vector drawings based on a 3D representation of a location, in accordance with one or more embodiments.

FIG. 3 illustrates an example of a view of a 3D representation of a physical scene (e.g., a room) at a location (e.g., a house), in accordance with one or more embodiments.

FIG. 4 illustrates an example of a three dimensional summary view of an isometric vector drawing of the surfaces (Wall 1, Wall 2, Wall 3, and Wall 4 in this example) in the physical scene from FIG. 3, in accordance with one or more embodiments.

FIG. 5 illustrates an example of a two dimensional floorplan orthographic vector drawing of the surfaces of the physical scene from FIG. 3, in accordance with one or more embodiments.

FIG. 6 illustrates a wall detail view of an orthographic vector drawing of Wall 1 (also shown in FIGS. 5, 4, and 3), in accordance with one or more embodiments.

FIG. 7 illustrates a wall detail view of an orthographic vector drawing of Wall 2 (also shown in FIGS. 5, 4, and 3), in accordance with one or more embodiments.

FIG. 8 illustrates a wall detail view of an orthographic vector drawing of Wall 3 (also shown in FIGS. 5 and 4), in accordance with one or more embodiments.

FIG. 9 illustrates a wall detail view of an orthographic vector drawing of Wall 4 (also shown in FIGS. 5 and 4), in accordance with one or more embodiments.

FIG. 10 illustrates another example of a three dimensional summary view of an isometric vector drawing of surfaces and contents in a different physical scene, in accordance with one or more embodiments.

FIG. 11 illustrates an example of a two dimensional floorplan orthographic vector drawing of the surfaces of the physical scene corresponding to FIG. 10, in accordance with one or more embodiments.

FIG. 12 illustrates wall detail views of orthographic vector drawings of Walls 3, 4, 5, 6, and 7 (also shown in FIGS. 10 and 11) and surfaces and/or contents, in accordance with one or more embodiments.

FIG. 13 illustrates wall detail views of orthographic vector drawing of Walls 2, 1 and 8 (also shown in FIGS. 10 and 11), in accordance with one or more embodiments.

FIG. 14 illustrates yet another example three dimensional summary view of an isometric vector drawing of surfaces and contents in a different physical scene of a multiroom, in accordance with one or more embodiments.

FIG. 15 illustrates an example of a two dimensional floorplan orthographic vector drawing of the surfaces of the physical scene corresponding to FIG. 14, in accordance with one or more embodiments.

FIG. 16 illustrates wall detailed views of orthographic vector drawings of Walls 1 and 2 (also shown in FIGS. 14 and 15) and surfaces and/or contents, in accordance with one or more embodiments.

FIG. 17 illustrates wall detail views of orthographic vector drawings of Walls 3 and 4 (also shown in FIGS. 14 and 15) and surfaces and/or contents, in accordance with one or more embodiments.

FIG. 18 and FIG. 19 depict exemplary photographs of a multiroom as viewed by a user and may be used for capturing input via a computing platform or user device, for the drawings shown in FIGS. 14-17, in accordance with one or more embodiments.

FIG. 20 illustrates an example of an application platform on computing platform presenting a graphical user interface to a user for scanning a room or physical scene for the drawings shown in FIGS. 14-17, in accordance with one or more embodiments.

FIG. 21 illustrates an exemplary 3D output model provided by the disclosed method and systems for processing and preparing isometric and/or orthographic vector drawings shown in FIG. 15, in accordance with one or more embodiments.

FIG. 22 illustrates still yet another example three dimensional summary view isometric vector drawing of surfaces and contents in still yet a different physical scene of a multiroom with a sub-room, in accordance with one or more embodiments.

FIG. 23 illustrates an example of a two dimensional floorplan orthographic vector drawing of the surfaces of the physical scene corresponding to FIG. 22, in accordance with one or more embodiments.

FIG. 24 illustrates wall detailed views of orthographic vector drawings of walls (also shown in FIGS. 22 and 23) and surfaces and/or contents, in accordance with one or more embodiments.

FIG. 25 illustrates an example of a two dimensional floorplan orthographic vector drawing of multiple rooms associated with a physical scene of a location, e.g., rooms throughout a floor of a house, in accordance with embodiments.

Features associated therewith and noted in the summary will be realized in view of the description below.

### DETAILED DESCRIPTION

As described above, the present systems and methods are configured generate a three dimensional (3D) representation of a location (an electronic virtual 3D representation), and output isometric and/or orthographic vector drawings based on the 3D representation. The vector drawings are generated by rendering views of the 3D representation in a scalable vector graphics (SVG) format, so that the views can be zoomed without blurring or other decreases in image viewability. Normally drawings like these might require hours to generate. Using the described systems and methods, these drawings can be generated in a few milliseconds. In an embodiment, the SVG drawings are generated in less than 500 milliseconds (ms). In another embodiment, the SVG drawings are generated in less than 100 ms. In yet another embodiment, the generated SVG drawings are generated in less than 75 ms.

The present systems and methods provide a solution for generating an output such as a report (e.g., in the form of a PDF, a web page, a mobile or web app display, a JSON API/webhook, a PNG image, a summary video, etc.) representing a scanned (e.g., video capture and/or capture with a series of still images) room or series of rooms (e.g., a physical scene) in a house and/or in other locations. The output includes the vector drawings described herein. Advantageously, the output includes sufficient detail for many reconstruction and/or other use cases. Example use cases may include automatically calculating a drywall area for a location; recognizing and/or determining an area of window, door, and/or other wall, floor, or ceiling cutouts; recognizing and/or determining perimeter measurement of an area such as a floor or ceiling; recognizing and/or determining an area of reference blocks such as islands, bathtubs, toilets, cabinets, and/or other permanent fixtures at a location; algorithmically generating high quality vector drawings and/or other graphics that traditionally require a trained draftsman; and/or other use cases. Notably, vector drawing frameworks are two dimensional (2D) systems, so rendering 3D objects is not trivial. For example, 3D models represent data in x, y, z coordinates, but in 2D, only x and y exist. As a result, the 2D drawing framework has to handle perspective and occlusion. Since the drawings described herein are more like architectural drawings and not plain artwork, the system needs to accurately represent the space, so there are tight tolerances to getting this correct.

The present systems and methods are superior to other systems at least because a 3D perspective in a vector drawing provides a bearing of a room to someone who has never been there before. This may be useful in remodeling, reconstruction, and repair scenarios (among other possible examples) where a technician being asked to provide a quote historically would have had access to the room, but is now dependent on a virtual representation. In addition, the vector drawings and/or other graphics are infinitely scalable, allowing for complicated drawings to be generated without loss of detail. For example, using the framework described herein, if a user pinch zooms a vector drawing, the zoomed view of the area enlarged by the user is still as clear as it was in the zoomed out view. Before now, a zoomed view like this would have likely required the generation of a separate zoomed image (whether automatically or manually generated). Further, the present systems and methods facilitate rendering any room and/or other physical scene in any camera position, and any location, thus providing whatever view of the physical scene is desired for a user's purpose.

With regard to past systems, manually drawn graphics are accurate and precise, but are slow to generate, and typically require a trained draftsperson. Raster graphics are often used for 3D images, but cannot scale infinitely, so complex shapes and other details are lost when an image is zoomed, for example.

The present systems and methods may be used for things like planning renovations to a home, which may require understanding the dimensions and/or current state of the home; obtaining insurance, which may require an inspection and accurate documentation of the home and its contents; and moving into a new home, which requires a reliable estimate as to whether one's belongings and furniture will fit, for example. The present systems and methods reduce or eliminate the time required for an onsite inspection (e.g., by contractor hired to complete renovations) including scheduling an appointment that is convenient for all parties; minimizes error and bias (e.g., because the computer based system described herein behaves the same every time, unlike people); provides accurate, auditable (e.g., recorded video data can be saved), non-human dependent measurements; and/or has other advantages.

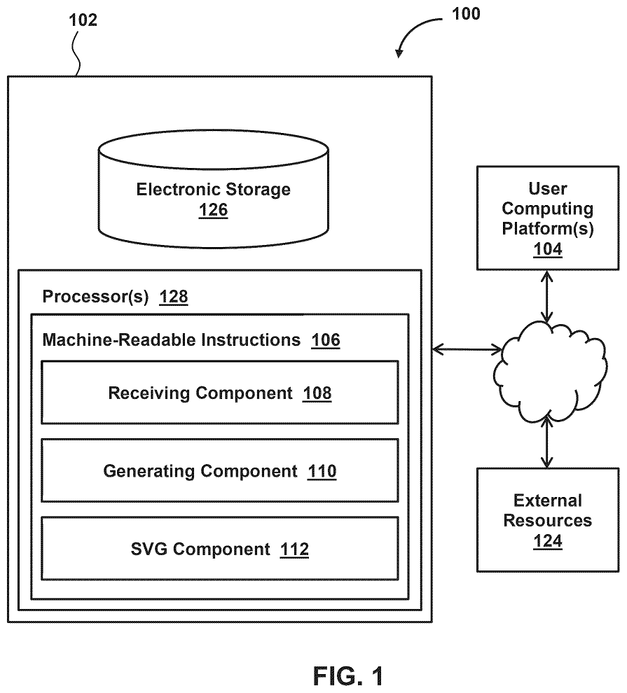

FIG. 1 illustrates a system 100 for generating a three dimensional (3D) electronic virtual representation of a physical scene at a location, and outputting isometric and/or orthographic vector drawings based on the 3D representation, in accordance with one or more embodiments. A physical scene may be indoors or outdoors at the location. The location may be any open or closed spaces for which the interactive 3D representation may be generated. For example, the physical scene at the location may be a room, a warehouse, a classroom, an office space, an office room, a restaurant room, a coffee shop, a room or rooms of a house or other structure, a porch or yard of the structure, etc.

In some embodiments, system 100 may include one or more servers 102. The server(s) 102 may be configured to communicate with one or more user computing platforms 104 according to a client/server architecture. The users may access system 100 via user computing platform(s) 104. System 100 utilizes input information from input devices such as cameras, depth sensors, microphones, accelerometers, location sensors, inertial measurement unit (IMU) data (e.g., data collected from an accelerometer, a gyroscope, a magnetometer, and/or other sensors), text data, questions asked by a human agent or a machine learning algorithm based on sent images, videos, previous answers as well as answers by the consumer on a mobile device (e.g., smartphone, tablet, and/or other mobile device that forms a user computing platform 104), and/or other information to generate the 3D representation of a physical scene. Generating may include following a set of machine readable instructions stored in a computer readable storage medium for generating, determining, running, displaying, etc., the three dimensional electronic representation, for example. The 3D representation of the physical scene may be similar to and/or the same as the 3D (electronic virtual) representations and/or models described in U.S. patent application Ser. No. 18/131,811 (titled “Scanning Interface Systems and Methods for Building a Virtual Representation of a Location” and filed Apr. 6, 2023) and/or U.S. patent application Ser. No. 17/194,075 (titled “Systems and Methods for Building a Virtual Representation of a Location” and filed Mar. 5, 2021), both of which are incorporated by reference in their entireties.

In some embodiments, server(s) 102, computing platform(s) 104, and/or external resources 124 may be operatively linked via one or more electronic communication links. For example, such electronic communication links may be established, at least in part, via a network such as the Internet and/or other networks. It will be appreciated that this is not intended to be limiting, and that the scope of this disclosure includes embodiments in which server(s) 102, computing platform(s) 104, and/or external resources 124 may be operatively linked via some other communication media.

User computing platforms 104 may communicate description data to server 102. Description data may include one or more of digital photos, images, videos, audio, local digital media items, connected digital media items, and/or other description data. Local digital media items may include digital media items stored locally at a given user computing platform 104. Connected digital media items may include digital media items stored remotely from a given user computing platform 104 such as at other user computing platforms 104, at other locations within system 100, and/or locations outside of system 100. Connected digital media items may be stored in the cloud.

A given computing platform 104 may include one or more processors configured to execute machine-readable instructions. The machine-readable instructions may be configured to enable an expert or user associated with the given computing platform 104 to interface with system 100 and/or external resources 124, and/or provide other functionality attributed herein to computing platform(s) 104. By way of non-limiting example, the given computing platform 104 may include one or more of a desktop computer, a laptop computer, a handheld computer, a tablet computing platform, a Netbook, a Smartphone, a gaming console, and/or other computing platforms.

External resources 124 may include sources of information, hosts and/or providers of social network platforms outside of system 100, external entities participating with system 100, and/or other resources. In some embodiments, some or all of the functionality attributed herein to external resources 124 may be provided by resources included in system 100.

Server(s) 102 may include electronic storage 126, one or more processors 128, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102. It should be noted that, while one or more operations are described herein as being performed by particular components of server 102, those operations may, in some embodiments, be performed by other components of server 102 or other components of system 100. As an example, while one or more operations are described herein as being performed by components of server 102, those operations may, in some embodiments, be performed by components of client a user computing platform 104.

Electronic storage 126 may comprise non-transitory storage media that electronically stores information. The electronic storage media of electronic storage 126 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Electronic storage 126 may store software algorithms, information determined by processor(s) 128, information received from server(s) 102, information received from computing platform(s) 104, and/or other information that enables server(s) 102 to function as described herein.

Processor(s) 128 may be configured to provide information processing capabilities in server(s) 102. As such, processor(s) 128 may include one or more of a digital processor, an analog processor, a digital circuit designed to process information, an analog circuit designed to process information, a state machine, and/or other mechanisms for electronically processing information. Although processor(s) 128 is shown in FIG. 1 as a single entity, this is for illustrative purposes only. In some embodiments, processor(s) 128 may include a plurality of processing units. These processing units may be physically located within the same device, or processor(s) 128 may represent processing functionality of a plurality of devices operating in coordination. The processor(s) 128 may be configured to execute machine-readable instruction 106 via components 108, 110, 112, and/or other machine-readable instruction components. Processor(s) 128 may be configured to execute machine-readable instruction components 108, 110, 112, and/or other machine-readable instruction components by software; hardware;

firmware; some combination of software, hardware, and/or firmware; and/or other mechanisms for configuring processing capabilities on processor(s) 128. As used herein, the term “machine-readable instructions” may refer to any code and/or other programming, and/or instructions that cause a computing device and/or server to perform the functionality attributed to the components of processors 128.

It should be appreciated that although components 108, 110, and 112 are illustrated in FIG. 1 as being implemented within a single processing unit, in embodiments in which processor(s) 128 includes multiple processing units, one or more of components 108, 110, and/or 112 may be implemented remotely from the other machine-readable instruction components. The description of the functionality provided by the different components 108, 110, and/or 112 described herein is for illustrative purposes, and is not intended to be limiting, as any of machine-readable instruction components 108, 110, and/or 112 may provide more or less functionality than is described. For example, one or more of machine-readable instruction components 108, 110, and/or 112 may be eliminated, and some or all of its functionality may be provided by other ones of machine-readable instruction components 108, 110, and/or 112. As another example, processor(s) 128 may be configured to execute one or more additional machine-readable instruction components that may perform some or all of the functionality attributed herein to one of machine-readable instruction components 108, 110, and/or 112.

The server(s) 102 and/or computing platform(s) 104 may be configured to execute machine-readable instructions 106. The machine-readable instructions 106 may include one or more of a receiving component 108, a generating component 110, an SVG component 112, and/or other components. One or more of components 108, 110, and/or 112, may include sub-components related to other applications of the present systems and methods. In some embodiments, some or all of the components may be located in server(s) 102, in computing platform(s) 104, a combination of the two, and/or other computing devices. The machine learning work (e.g., the operations performed by one or more processors 128 and/or the one or more electronic models described herein) may be performed in one or more of the cloud, a mobile device, and/or other devices.

One or more of components 108-112 may cooperate with (e.g., send information to, receive information from, and/or other cooperation) and/or form some or all of the one or more electronic models described herein. Machine readable instructions 106 may be configured to cause server 102 (and/or other computing devices) to generate and/or execute one or more electronic models. The one or more electronic models may comprise machine learning and/or other artificial intelligence models. The one or more electronic models may comprise various networks, algorithms, equations, lookup tables, heuristics or conditions, 3D geometric models, and/or other models. In some embodiments, the one or more electronic models may include classification algorithms, neural networks, and/or combinations thereof.

The one or more electronic models may include a machine learning model that includes a deep neural net such as a convolutional neural network (CNN), recurrent neural network (RNN), long short term memory (LSTM) network, etc. However, the one or more electronic models are not limited to only these types of networks. The model(s) may be configured to read images either sequentially or as a batch. Multiple different algorithms may be used to process one or more different inputs. In some embodiments, the one or more electronic models may include a multi-stage electronic model for generating a 3D representation comprising data items corresponding to surfaces and/or contents in a physical scene, identifying objects in the physical scene, and/or for other purposes. The multi-stage model may comprise, for example, a trained neural network having a first stage that identifies particular surfaces and/or objects in the physical scene, and a second stage configured to generate the 3D electronic representation of the physical scene.

Receiving component 108 may be configured to receive description data of a physical scene (e.g., a room) at a location (e.g., a user's house). The description data may be captured by a user computing platform 104 and/or other devices, for example. In some embodiments, description data comprises one or more images of the physical scene (e.g., in the form of a video). The one or more images may be generated via a camera associated with a user, e.g., via camera on a mobile device or user computing platform 104. In some embodiments, the description data comprises one or more media types. The one or more media types comprise at least one or more of video data, image data, audio data, text data, user interface/display data, and/or sensor data. In some embodiments, the description data is time stamped, geo stamped, user stamped, and/or annotated in other ways.

The description data may be obtained by one or more of a camera, a computer vision device, an inertial measurement unit, a depth sensor, and/or other sensors. In some embodiments, the description data includes data generated by video and/or image acquisition devices, and/or voice recording devices, a user interface, and/or any combination thereof. In some embodiments, the description data is generated via a user interface (e.g., of a user computing platform 104), an environment sensor (e.g., that is part of a user computing platform 104 and/or other computing systems), an external location information database (e.g., included in external resources 124), and/or other sources of information. The data may be generated responsive to a user request, and/or automatically by the system (e.g., without initiation by a user). In some embodiments, the description data is captured by a mobile computing device (e.g., a user computing platform 104) associated with a user and transmitted to one or more processors 128 (e.g., receiving component 108) with or without user interaction.

In some embodiments, receiving description data comprises receiving sensor data from one or more environment sensors. The one or more environment sensors comprise a global positioning system (GPS) sensor, an accelerometer, a gyroscope, a barometer, a microphone, a depth sensor, and/or other sensors.

The received description data provides a description of the physical scene at the location (e.g., description data). The description data may include interior and/or exterior information about the location, and/or other information. Receiving component 108 may be configured such that graphical user interfaces, such as those provided by native applications on mobile devices or browser applications (e.g., by computing platforms 104), may be controlled to enable interactive instructions for the user during a description data (e.g., video) capture process. These graphical user interfaces (controlled by receiving component 108) can also enable a user to provide further text, audio, image, and video data in support of the captured images and videos. Data from additional sensors, including GPS, accelerometers, gyroscopes, barometers, depth sensors, microphones, and/or other sensors, can also be used for capturing properties of the surrounding environment.

By way of a non-limiting example, a user (and/or system 100 without the user) can use cameras, user interfaces, environmental sensors, external information databases, and/or other sources to acquire data about a location, and its contents and structures. The information collected can subsequently be input to automated processes (e.g., the one or more machine learning models and processor functionality described herein) for further identifying surfaces, contents, structures, etc.

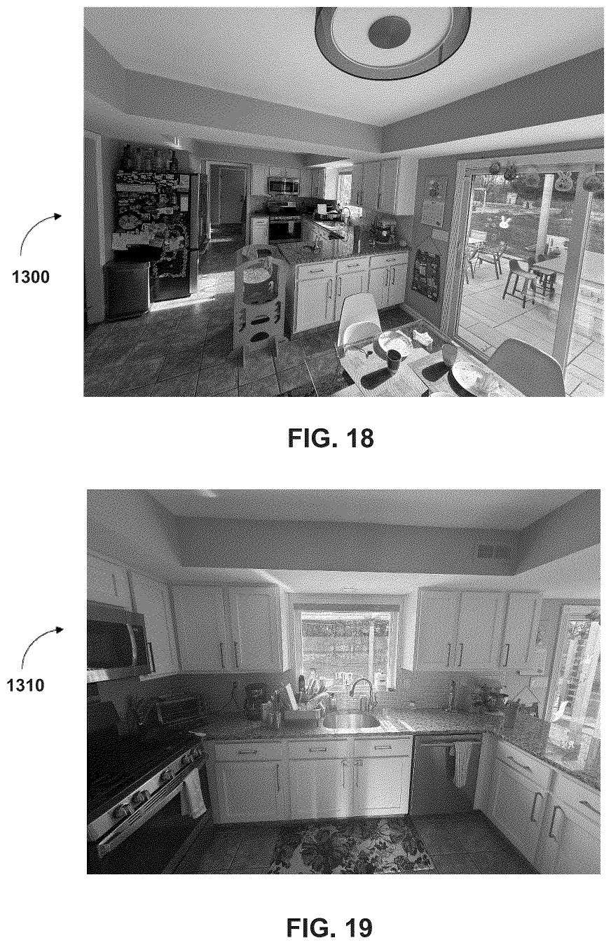

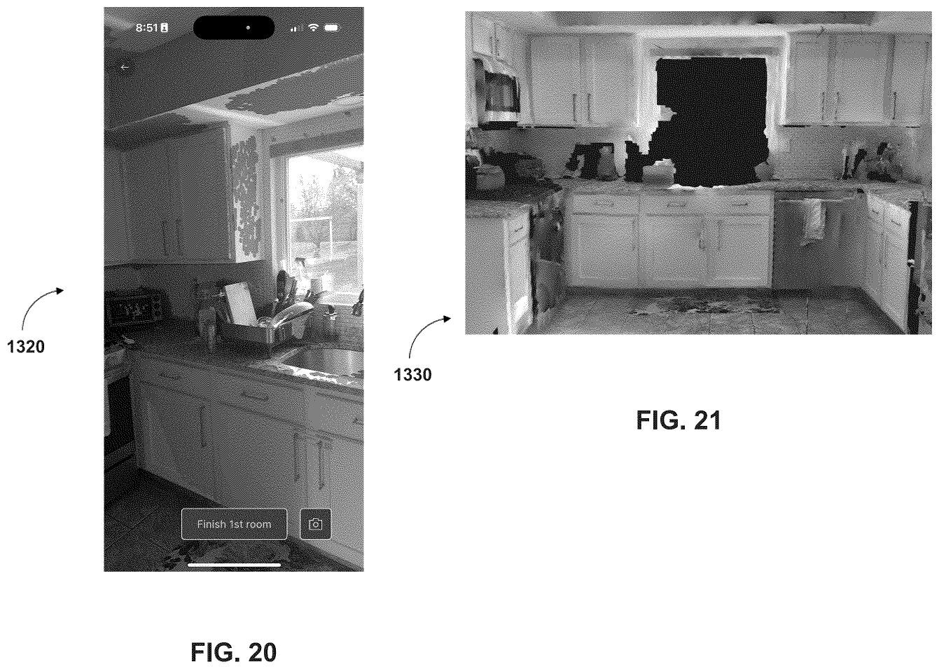

One example method of data capture involves capturing video recordings. These recordings may be processed (e.g., by the one or more electronic models and/or components 108-112) in real time during the capture or captured in advance and processed at some later point in time. In embodiments, a physical scene at a location, such as shown and described with reference to FIGS. 18 and 19 in photographs, is captured as input. During a real time video capture, a graphical user interface (e.g., controlled by receiving component 108 and presented by a computing platform 104 associated with the user) can provide interactive instructions to the user to guide them through the process. One example of this is shown and described with reference to FIG. 20. The one or more electronic models (e.g., a machine learning model) and/or processing components processing the real time video stream can identify if certain surfaces, contents, or structures require additional captures by the user. An example of a 3D output model provided by the disclosed methods and system is shown in an described with reference to FIG. 21. When this occurs, the user may be immediately prompted to capture additional images or videos of specific aspects of the physical scene. When a user captures a video in advance and later uploads it to a server through the graphical user interface, it can subsequently be processed by the same electronic (machine learning) model(s) to obtain an inventory of identified surfaces, contents, and structures, for the location. Audio and other sensor data may be captured by the user as well, providing more context for the image and video recordings. The same data capture flow may be used when a user captures a collection of still images of the physical scene, including general images of the physical scene as well as close ups of surfaces and/or other items of interest that might be necessary. Additionally, the real time video stream capture format may be incorporated as part of a collaborative process with a third person, who can provide interactive guidance to the user through a graphical user interface, for example.

In some embodiments, a graphical user interface for interactively capturing the physical scene at the location through images and video with visual feedback may be provided by receiving component 108 via a user computing platform 104 to a user, for example. The feedback may include, but is not limited to, real-time information about a status of the interactive 3D electronic representation being constructed, natural language instructions to a user, or audio or visual indicators of information being added to the interactive 3D electronic representation. The graphical user interface also enables a user to pause and resume data capture within the location. Accordingly, the interactive 3D electronic representation may be updated upon receiving additional data related to the location.

Generating component 110 is configured to generate, with a trained machine learning model, the 3D representation of the physical scene based on the description data and/or other information. The three dimensional representation comprises data items corresponding to surfaces and/or contents in the physical scene, and/or other information. In some embodiments, the surfaces and/or contents in the physical scene comprise walls, a ceiling, a floor, a window, a door, a wall opening, a support column, a household appliance, a countertop, a cabinet, a permanent fixture, a staircase, a toilet, a bathtub, a fireplace, the type of flooring, and/or other items. In some embodiments, generating the interactive 3D representation of the physical scene comprises rendering a mesh. In some embodiments, the 3D representation comprises a textured or untextured three-dimensional mesh with vertices connected by edges, defining triangular or quadrilateral planar faces. A texture map may comprise position, surface normal, and/or other information associated with the vertices, faces, and/or other components of the three dimensional representation. The vertices may be thought of like stars and polygons (the “constellations”) can be represented and labeled as different items. For example, a rectangular door would be represented as a set of 4 vertices in x/y/z coordinate space.

In some embodiments, the three dimensional representation of the physical scene is stored as a triangle mesh, which comprises a graph data structure storing lists of vertices and a list of indices that indicate which vertices are joined together as a triangle, with each vertex comprising attributes including a position, a color, a normal vector, a parametrization coordinate, an instance index and a semantic class index. Generating the three dimensional representation of the physical scene based on the description data may comprise transferring detections of physical scene structures indicated by the data items to the three dimensional representation by: predicting, with the trained machine learning model, semantic classes for two dimensional input video frames included in the description data, projecting mesh vertices onto a camera image plane to map each of the mesh's vertices to image coordinates and determine a predicted label; determining whether a projected mesh vertex falls into a region labeled as a floor, wall, or ceiling; and determining a per mesh triangle label, where a triangle is labeled as part of the floor, wall, or ceiling if all of its adjacent vertices are labeled as floor, wall, or ceiling.

Generating component 110 is also configured to extract the data items (e.g., surfaces and/or contents of a physical scene) from the interactive three dimensional representation with the trained machine learning model, and determine attributes of the data items. The attributes comprise dimensions and/or locations of the surfaces and/or contents of the physical scene. In some embodiments, extracting the data items includes providing the interactive 3D representation as an input to the trained machine learning model to identify the data items. For example, the trained machine learning model may comprise a convolutional neural network (CNN) and may be trained to identify objects and structures in multiple physical scenes as the data items. In some embodiments, generating component 110 is configured to identify a subset of the data items with the trained machine learning model. The subset of the data items may comprise a ceiling, a floor, and walls of the physical scene.

As a non-limiting example, according to embodiments, attributes of the data items identified and prepared by generating component 110 refers to architectural annotations which are generated for surfaces and/or contents of the isometric and/or orthographic vector drawings. In embodiments, the attributes/generated architectural annotations for a room plan and/or wall elevations are configured to include dimensions, and the dimensions are configured to be rendered in a hierarchy with at least two tiers comprising inner tiers and an outer tiers. Such tiers may indicate, for example, each window, door, and/or opening, etc. within the walls in one tier, and at least an overall length of each wall segment of walls in another tier. As noted in the Examples later below, in embodiments, inner tier(s) may indicate applicable position and width of each window, door, and/or opening, etc. within the walls, and outer tier(s) may indicate at least an overall length of each wall segment of the walls, each of which also has a wall elevation associated therewith. In some embodiments, the outer tiers further indicate a height of each wall segment. Rules or guidelines regarding addition of tiers (or use of tiers like inner tiers and outer tiers) may be considered by generating component 110, in accordance with embodiments. For example, in an embodiment, inner tiers are only added if (a) a wall segment of the walls has an opening, door and/or window, and/or (b) a wall segment of the walls has permanent fixtures attached thereto. In such cases, the outer tiers are configured to offset an additional distance from wall outlines indicated in the inner tiers.

According to embodiments, the attributes/generated architectural annotations identified and prepared by generating component 110 for the room plan and/or wall elevations are configured to include tags or identification tags, and the dimensions are configured to be offset by a predetermined measurement range from wall outlines of the walls. Tags for the walls may be rendered (by SVG component 112, for example, described below) outside of the dimensions and/or wall elevations, for example. In embodiments, attributes/architectural annotations are generated for each of the extracted key data items, and isometric projections of interior rooms are generated as part of the drawings. In some embodiments, the generated architectural annotations by generating component 110 may include one or more of: a label, identification tags, and dimensions. In some embodiments, a rendered two dimensional floorplan is updated by generating component 110 and then rendered via SVG component 112 with the generated architectural annotations. Also, in embodiments, edges and lines of varying line-weight and/or opacity may be determined by generating component 110 and rendered, for example, by SVG component 112 on such drawings to provide depth, for example. In some embodiments, generated architectural annotations may include dynamic tags that maintain consistent sizing with scaled floor plans and wall elevations of the two dimensional floorplan. Tags for the walls, windows, and/or doors may be rendered by SVG component 112 relative to a predefined center-point on the extracted key data items.

One or more machine learning models may work cooperatively to generate an interactive 3D representation. For example, in an embodiment, a first machine learning model may be configured to generate the interactive 3D representation, a second machine learning model may be trained to generate semantic segmentation or instance segmentation information or object detections from a given input image, a third machine learning model may be configured to estimate pose information associated with a given input image, and a fourth machine learning model may be configured to spatially localize metadata to an input image or an input 3D model (e.g., generated by the first machine learning model). In another embodiment, a first machine learning model may be configured to generate the interactive 3D representation, a second machine learning model may be trained to generate semantic segmentation or instance segmentation information or object detections from a given input 3D model or images, a third machine learning model may be configured to spatially localize metadata to an input 3D model or images. In an embodiment, two or more of the machine learning models may be combined into a single machine learning model by training the single machine learning model accordingly. In the present disclosure, a machine learning model may not be identified by specific reference numbers like “first,” “second,” “third,” and so on, but the purpose of each machine learning model will be clear from the description and the context discussed herein. Accordingly, a person of ordinary skill in the art may modify or combine one or more machine learning models to achieve the effects discussed herein. Also, although some features may be achieved by a machine learning model, alternatively, an empirical model, an optimization routine, a mathematical equation (e.g., geometry-based), etc. may be used.

In an embodiment, a system or a method may be configured to generate the 3D representation of the physical scene at the location with spatially localized information of elements within the location being embedded in the 3D representation. For example, in an embodiment of a trained machine learning model (AI) (e.g., processors 128 shown in FIG. 1 and/or the one or more electronic (machine learning) models described herein), may include natural language processing algorithms, machine learning algorithms, neural networks, regression algorithms, and/or other artificial intelligence algorithms and electronic models. Description data such as video or audio (e.g., provided by a user such as a consumer) may be divided into smaller segments (units) using spatial, and/or temporal constraints as well as other data such as context data. For example, a video may be divided into multiple frames and poor quality images with low lighting and/or high blur may be filtered out. Similarly, an audio input may filter out segments comprising background noise and create units of audio where a speaker (e.g., the consumer) is actively communicating.

A neural network (e.g., convolutional and/or recurrent) may be based on a large collection of neural units (or artificial neurons). The one or more neural networks may loosely mimic the manner in which a biological brain works (e.g., via large clusters of biological neurons connected by axons). Each neural unit of a neural network may be connected with many other neural units of the neural network. Such connections may be enforcing or inhibitory in their effect on the activation state of connected neural units. In an embodiment, each individual neural unit may have a summation function that combines the values of all its inputs together. In an embodiment, each connection (or the neural unit itself) may have a threshold function such that a signal must surpass the threshold before it is allowed to propagate to other neural units. These neural network systems may be self-learning and trained, rather than explicitly programmed, and can perform significantly better in certain areas of problem solving, as compared to traditional computer programs. In an embodiment, the one or more neural networks may include multiple layers (e.g., where a signal path traverses from front layers to back layers). In an embodiment, back propagation techniques may be utilized by the neural networks, where forward stimulation is used to reset weights on the “front” neural units. In an embodiment, stimulation and inhibition for the one or more neural networks may be freer flowing, with connections interacting in a more chaotic and complex fashion. In an embodiment, the intermediate layers of the one or more neural networks include one or more convolutional layers, one or more recurrent layers, and/or other layers.

The one or more neural networks may be trained (i.e., whose parameters are determined) using a set of training data. The training data may include a set of training samples. Each sample may be a pair comprising an input object (typically a vector, which may be called a feature vector) and a desired output value (also called the supervisory signal)—e.g., an input-output pair. As described above, training inputs may be images, annotations, and/or other information, for example. A training algorithm analyzes the training data and adjusts the behavior of the neural network by adjusting the parameters (e.g., weights of one or more layers) of the neural network based on the training data. For example, given a set of N training samples of the form {(x₁, y₁), (x₂, y₂), . . . , (x_{N}, Y_{N})} such that xᵢ is the feature vector of the i-th example and yᵢ is its supervisory signal, a training algorithm seeks a neural network g:X→Y, where X is the input space and Y is the output space. A feature vector is an n-dimensional vector of numerical features that represent some object (e.g., an image of a room with objects to be moved as in the example above). The vector space associated with these vectors is often called the feature space. After training, the neural network may be used for making predictions using new samples (e.g., images of different rooms).

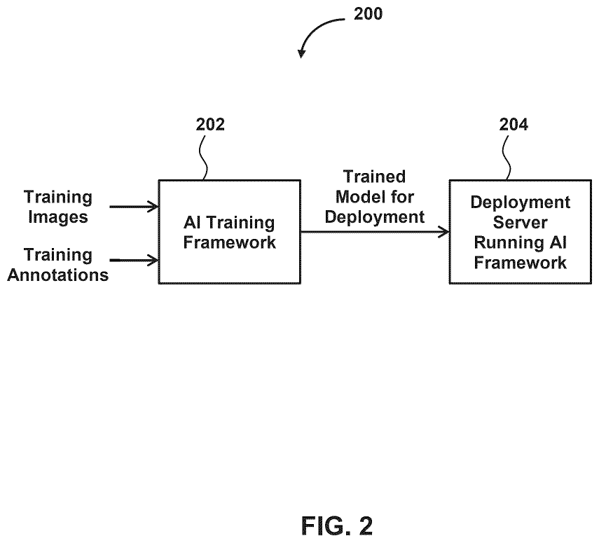

FIG. 2 illustrates an artificial intelligence (AI) (e.g., one or more electronic machine learning models) model 200 and/or framework 200 that may be trained to recognize surfaces and/or contents in a physical scene at a location, and generate a 3D representation, in accordance with one or more embodiments. Model 200 may form some or all of generating component 110 (FIG. 1), for example. Model 200 may be trained with training data. The training data may comprise input output training pairs associated with each potential data item (e.g., surfaces and/or contents in a physical scene). Model 200 (e.g., a machine learning model) may be trained by obtaining physical scene data associated with a specified physical scene at the location (where the physical scene data includes an image, a video or a three dimensional digital model associated with the specified physical scene); and training model 200 with the physical scene data to predict a specified set of surfaces and/or contents in the specified physical scene such that a cost function that is indicative of a difference between a reference set of surfaces and/or contents and the specified set of contents is minimized. Trained model 200 is configured to predict spatial localization data of the data items. The spatial localization data corresponds to location information of the surfaces and/or contents in the physical scene.

For example, multiple training images with surfaces, contents, etc. that need to be detected may be presented to an artificial intelligence (AI) framework 202 for training. Training images may contain surfaces such as walls, ceilings, floors, and or other information. Each of the training images may have annotations (e.g., location of surfaces in the image, coordinates, and/or other annotations) and/or pixel wise classification for contents, walls, floors, ceilings, and/or other surfaces, and/or other training images. Responsive to training being complete, the trained model (and/or one or more trained models) may be sent to a deployment server 204 (e.g., server 102 shown in FIG. 1) running a machine learning (e.g., AI) framework. It should be noted that training data is not limited to images and may include different types of input such as audio input (e.g., voice, sounds, etc.), user entries and/or selections made via a user interface, scans and/or other input of textual information, and/or other training data. The models, based on such training, be configured to recognize voice commands and/or input, textual input, etc.

Deployment server 204 may be a standalone server and/or a module that may be deployed as part of an app in a user's smartphone, tablet, and/or other personal computing device, in accordance with one or more embodiments.

Returning to FIG. 1, SVG component 112 is configured to generate one or more isometric and/or orthographic vector drawings of the surfaces and/or contents in the physical scene based on the three dimensional representation and/or other information. In some embodiments, the one or more isometric and/or orthographic vector drawings are generated in real time responsive to a user computer platform 104 receiving user input requesting generation (and/or an indication of such a request provided to server 102, for example). In some embodiments, the one or more isometric and/or orthographic vector drawings are generated automatically, without a need for user input.

In some embodiments, the one or more isometric and/or orthographic vector drawings are generated using a scalable vector graphics (SVG) two dimensional file format. In some embodiments, generating the one or more isometric and/or orthographic vector drawings comprises sorting the data items based on their locations in the three dimensional representation of the physical scene at the location, and rendering the one or more isometric and/or orthographic vector drawings back to front, starting with surfaces and/or contents that are farthest from a view location for the one or more isometric and/or orthographic vector drawings. In some embodiments, generating the one or more isometric and/or orthographic vector drawings using SVG, back to front in the physical scene at the location, facilitates infinite scaling of the one or more isometric and/or orthographic vector drawings without appreciable without appreciable blurring.

Creating a drawing in SVG that has a sense of depth requires building an indexed mesh to arrange each wall, or face, of the room by its position along a set camera global position and transform. The order of the faces in the indexed mesh will be different with respect to the camera input. With this ordered indexed mesh, a semblance of a rendering pipeline can be implemented in which it will draw the furthest face as a solid colored 2D vector drawing in the background. Then working through the indexed mesh, the drawings will continue layering until the last item in the indexed mesh is reached and the nearest item to the camera is drawn.

In some embodiments, the one or more isometric and/or orthographic vector drawings of the surfaces and/or contents in the physical scene comprise a three dimensional summary view, a two dimensional floorplan, a wall detail view, and/or other drawings. Generating the three dimensional summary view may comprise extracting key data items comprising walls, windows, and/or doors from the three dimensional representation of the physical scene, projecting the three dimensional representation in an isometric view, and rendering the three dimensional summary view using a scalable vector graphics (SVG) two dimensional file format based on the projecting. Generating the two dimensional floorplan may comprise extracting the key data items, projecting the three dimensional representation in a top down view, and rendering the two dimensional floorplan using the SVG two dimensional file format based on the projecting. Generating the wall detail view may comprise extracting the key data items, positioning a camera view of the three dimensional representation looking at a wall of interest, and generating and rendering the wall detail view using the SVG two dimensional file format, based on the camera view, for output.

As described with respect to the generating component 110, SVG component 112 may be configured to render attributes, e.g., in the form of architectural annotations, of the data items identified on the isometric and/or orthographic vector drawings, according to embodiments herein. Rendering by SVG component 112 may also be guided by the use of a hierarchy of tiers as analyzed by generating component 110. In embodiments, SVG component 112 may also render identification tags, dimension, labels, etc. in a particular location, e.g., tags outside of the dimensions and/or wall elevations, or relative to a predefined center-point on the extracted key data items, for example. SVG component 112 may also be configured to output varying weights, shading, and/or opacities, e.g., for edges and lines on drawings, to increase distinctions and relay additional information and/or features in the generated and/or rendered output based on the image data that is received from the camera.

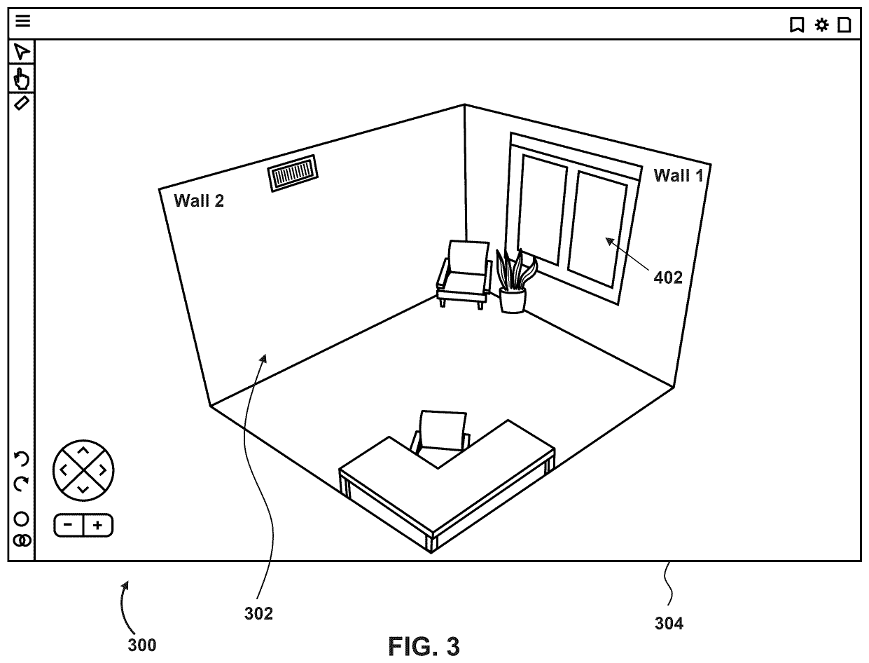

By way of several non-limiting examples, FIGS. 3-9 illustrate several examples of isometric and/or orthographic vector drawings of the surfaces and/or contents in a physical scene generated based on a three dimensional representation.

FIG. 3 illustrates an example of a view 300 of a 3D representation 302 of a physical scene (e.g., a room) at a location (e.g., a house) in a browser 304 (in this example). The 3D representation 302 may be output by generating component 110 shown in FIG. 1, for example. The 3D representation 302 may comprise a representation of detected surfaces (e.g., the mesh described above) in a document object model (DOM) loaded in a desktop or mobile browser 304. As described above, the mesh comprises thousands of small triangles (faces) that have been detected by generating component 110. View 300 can be manipulated by a user via mouse and/or other browser 304 interactions which change a user's perspective of interactive 3D representation 302.

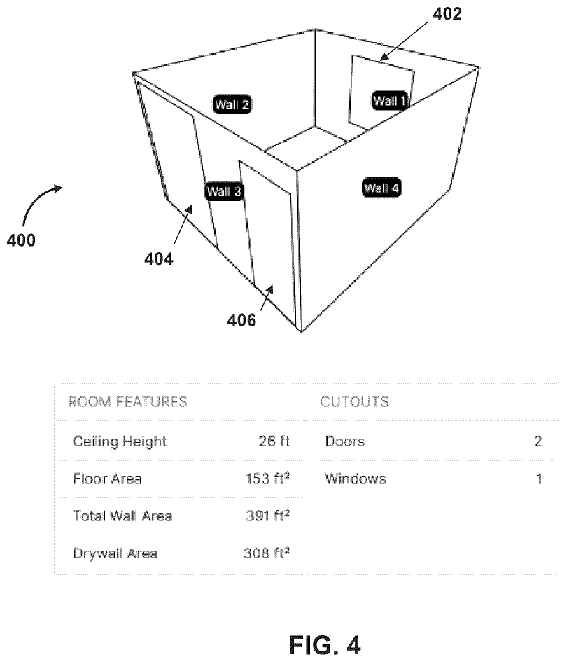

FIG. 4 illustrates an example three dimensional summary view isometric vector drawing 400 of the surfaces (Wall 1, Wall 2, Wall 3, and Wall 4 in this example) in the physical scene from FIG. 3. Generating the three dimensional summary view may comprise extracting key data items comprising walls (e.g., Walls 1-4), windows (e.g., window 402), doors (e.g., door 404 and door 406) from the 3D representation 302 (FIG. 3) of the physical scene (note that in this example door 406 would appear to be positioned in front of the desk in FIG. 3, which may not be ideal in an actual room, but which is nonetheless used as an example here to demonstrate the principles described herein), projecting 3D representation 302 in an isometric view (as shown in FIG. 4), and rendering the three dimensional summary view isometric vector drawing 400 using a scalable vector graphics (SVG) two dimensional file format based on the projecting (e.g., see SVG component 112 shown in FIG. 1 and described above).

FIG. 4 also illustrates several example attributes, determined with the trained machine learning model and/or processing modules (as described herein). In this example, the attributes comprise dimensions and quantities associated with Walls 1-4, a ceiling, a floor, the doors 404 and 406, and window 402. That is, in accordance with an embodiment, such attributes of the data item(s) like walls, doors, windows, etc. may refer to architectural annotations that are generated for such surfaces and/or contents in generated drawings. Specifically, FIG. 4 describes example room feature dimensions for ceiling height, floor area, total wall area, and a drywall area (for one example use case). FIG. 4 also lists quantities of detected cutouts (e.g., doors 404 and 406, and window 402).

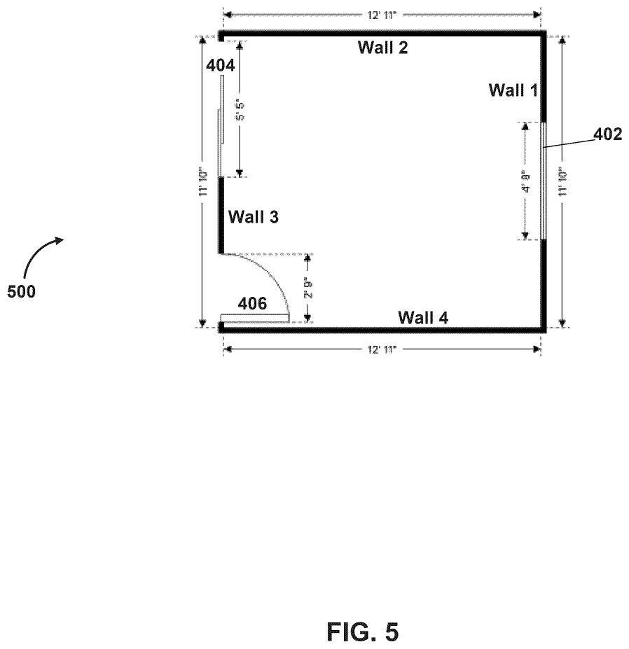

FIG. 5 illustrates an example two dimensional floorplan orthographic vector drawing 500 of the surfaces of the physical scene from FIG. 3. Generating the two dimensional floorplan may comprise extracting the key data items (e.g., Walls 1-4, window 402, and doors 404 and 406 in this example), projecting the three dimensional representation in a top down view (e.g., as shown in FIG. 5), and rendering the two dimensional floorplan using the SVG two dimensional file format based on the projecting. In FIG. 5, example attributes determined with the trained machine learning model and/or processing modules (as described herein) comprise dimensions associated with Walls 1-4, the doors 404 and 406, and window 402.

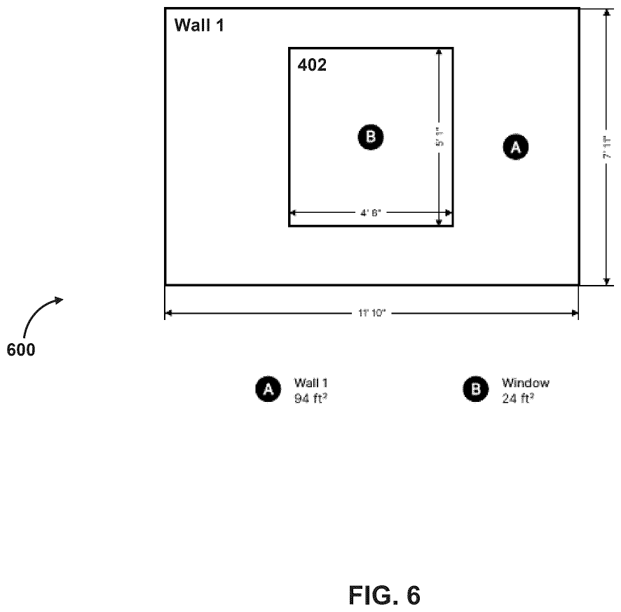

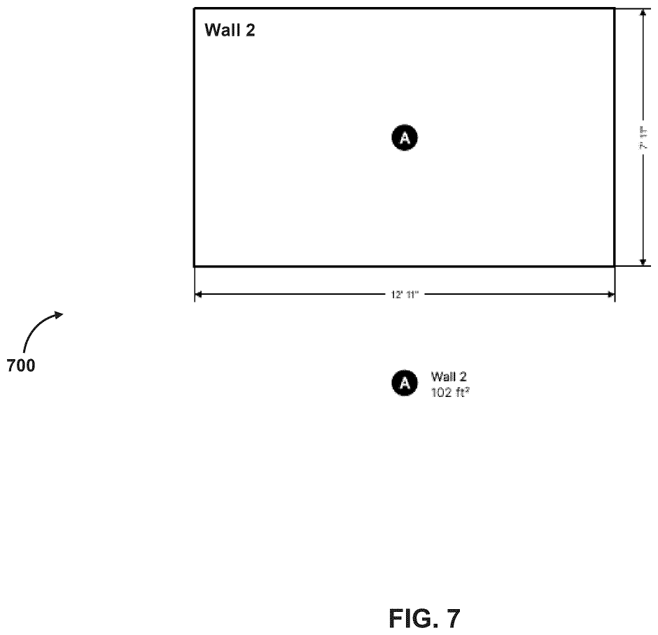

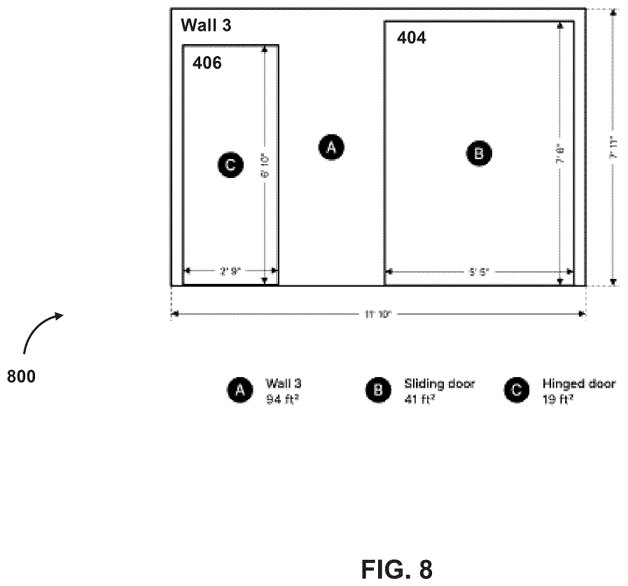

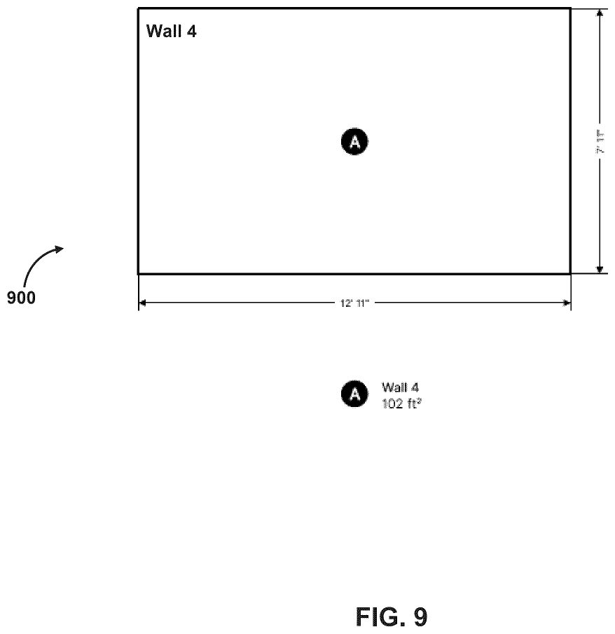

FIG. 6 illustrates a wall detail view orthographic vector drawing 600 of Wall 1 (also shown in FIGS. 5, 4, and 3). FIG. 7 illustrates a wall detail view orthographic vector drawing 700 of Wall 2 (also shown in FIGS. 5, 4, and 3). FIG. 8 illustrates a wall detail view orthographic vector drawing 800 of Wall 3 (also shown in FIGS. 5 and 4). FIG. 9 illustrates a wall detail view orthographic vector drawing 900 of Wall 4 (also shown in FIGS. 5 and 4). Generating these wall detail view orthographic vector drawings comprises extracting the key data items (e.g., walls, doors, windows, etc.), positioning a camera view of 3D representation 302 (FIG. 3) looking at a wall of interest, and generating and rendering the wall detail view using the SVG two dimensional file format, based on the camera view, for output, i.e. via generating component 110 and rendering component 112. In FIGS. 6-9, example attributes determined with the trained machine learning model and/or processing modules (as described herein) comprise dimensions associated with Walls 1-4, the doors 404 and 406, and window 402; and areas associated with the walls, doors, and windows.

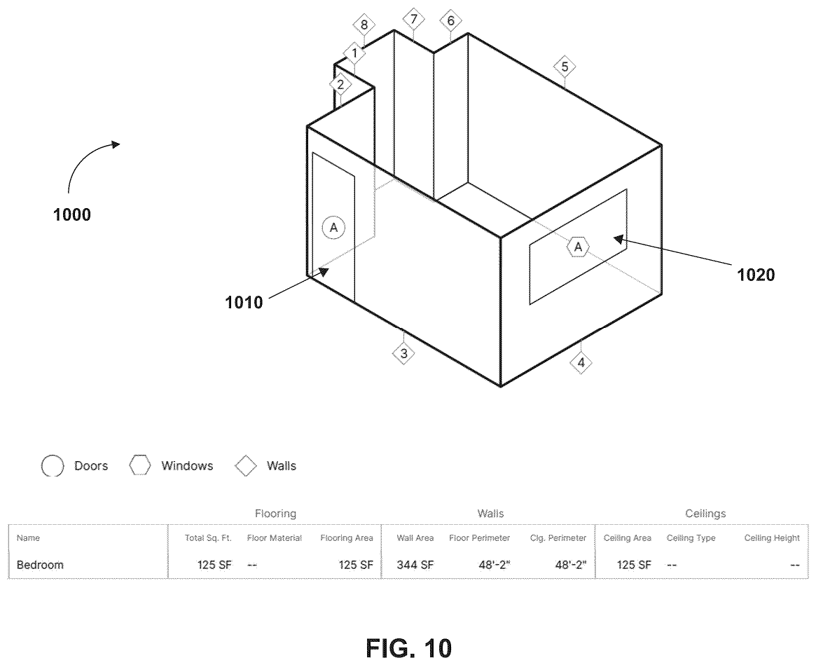

Further details regarding generating attributes of data items as architectural annotations for surfaces and/or contents and/or extracted key data items are described with reference to the embodiments disclosed in FIGS. 10-13 and FIGS. 14-17. As previously mentioned, in embodiments, attributes of the data items refers to architectural annotations that are generated for the surfaces and/or contents of the generated one or more isometric and/or orthographic vector drawings. According to an embodiment, the generated architectural annotations may include one or more of: a label, identification tags, and dimensions. FIGS. 4-9 include non-limiting examples of labels in the form of words (e.g., Wall 1), identification tags in the form of letters (e.g., A and B), as well as dimensions in terms of feet, inches, and square footage. In some embodiments, the generated one or more isometric and/or orthographic vector drawings are rendered with the generated architectural annotations based on a drawing scale of the drawings generated using the scalable vector graphics (SVG) two dimensional file format. In embodiments, architectural annotations for each of the extracted key data items may be generated, and the rendered three dimensional summary view may be updated with the generated architectural annotations.

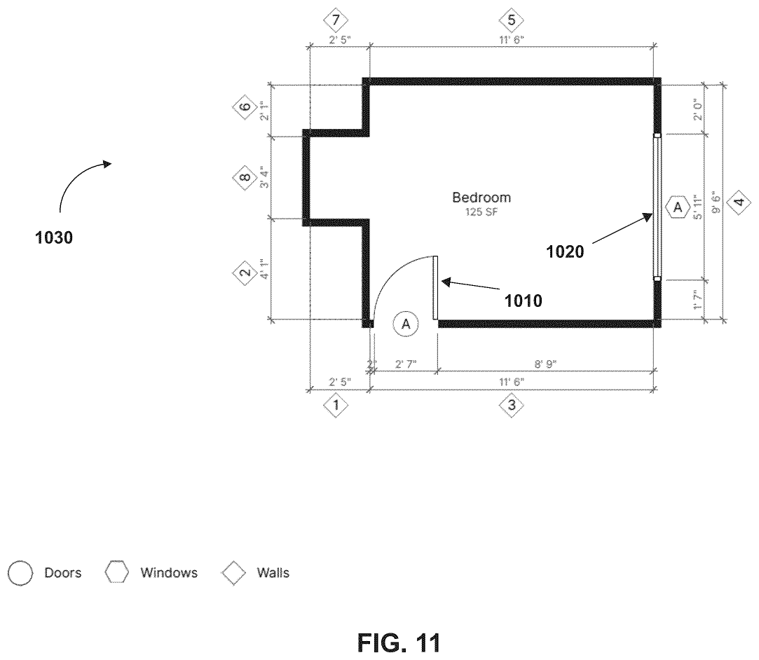

FIG. 10 illustrates another example embodiment of three dimensional summary view of an isometric vector drawing 1000 of surfaces and contents in a different physical scene, e.g., a bedroom, in accordance with embodiments. FIGS. 11-13 further illustrate generations and renderings corresponding to the view of FIG. 10. In particular, FIGS. 10-13 include examples of labels in the form of letters and numbers (e.g., A, B, . . . . Z, and 1, 2, 3, . . . . N) (e.g., Doors, windows, and walls) as shown in the corresponding Key, identification tags in the form of shapes and color (e.g., Blue Circle, Red Hexagon, Green Diamond, etc.) that correspond to particular surfaces and/or contents as defined by a generated Key (e.g., Doors, Windows, and Walls, etc. (respectively)), as well as dimensions in terms of feet, inches, and square footage. Labels and tags can be interchangeable; in embodiments, measurements are a type of annotation that show a dimension, while labels/tags are a type of annotation that add a category or identifier to a part of the drawing.

Specifically, shown in the isometric vector drawing 1000 are surfaces (Wall 1, Wall 2, Wall 3, Wall 4, Wall 5, Wall 6, Wall 7, and Wall 8, in this example, labeled with numbers 1-8 and diamond shaped tags, respectively) in the physical scene of a bedroom. Generating the three dimensional summary view may comprise extracting key data items comprising walls (e.g., Walls 1-8), windows (e.g., a fixed window or picture window 1020), door (e.g., single swing door 1010) from a 3D representation (not shown) of a physical scene, projecting the 3D representation in an isometric view (as shown in FIG. 10), and rendering the three dimensional summary view isometric vector drawing 1000 using a scalable vector graphics (SVG) two dimensional file format based on the projecting (e.g., see SVG component 112 shown in FIG. 1 and described above).

Further, architectural annotations for the surfaces and/or contents-here including labels, identification tags, and dimensions-are generated and then the isometric drawing is rendered with the generated architectural annotations based on a drawing scale of the drawings generated using the SVG two dimensional file format. FIG. 10 also illustrates several example attributes in form of architectural annotations determined with the trained machine learning model and/or processing modules (as described herein). In this example, the attributes comprise dimensions and identification tags associated with Walls 1-8 (including sequential number tags of a green diamond), a ceiling, a floor or flooring, door 1010 (including the tag A in blue circle), and window 1020 (including the tag A in a red hexagon). Specifically, FIG. 10 describes example room feature dimensions for floor area and total square feet, total wall area including floor perimeter, and ceiling area (for one example use case). Although not shown in FIG. 10, quantities of contents and/or detected cutouts (such as those examples shown in FIG. 4) may also be provided.

FIG. 11 illustrates an example of a two dimensional floorplan orthographic vector drawing 1030 of the surfaces of the physical scene corresponding to FIG. 10, in accordance with embodiments. Generating the two dimensional floorplan may comprise extracting the key data items (e.g., Walls 1-8, door 1010, window 1020 in this example), projecting the three dimensional representation in a top down view (e.g., as shown in FIG. 11), and rendering the two dimensional floorplan using the SVG two dimensional file format based on the projecting. In FIG. 11, example attributes are generated and provided (i.e., rendered) in the form of generated architectural annotations determined with the trained machine learning model and/or processing modules (as described herein) and comprise dimensions and identification tags associated with Walls 1-8, the door 1010, and window 1020, as described above. In addition to the labels and Key previously mentioned, additional word labels, e.g., Bedroom, may be generated.

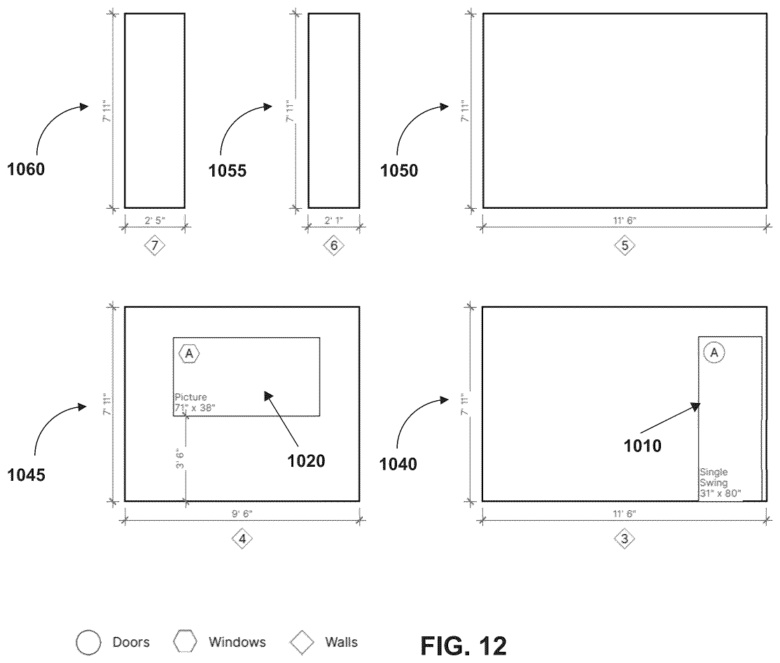

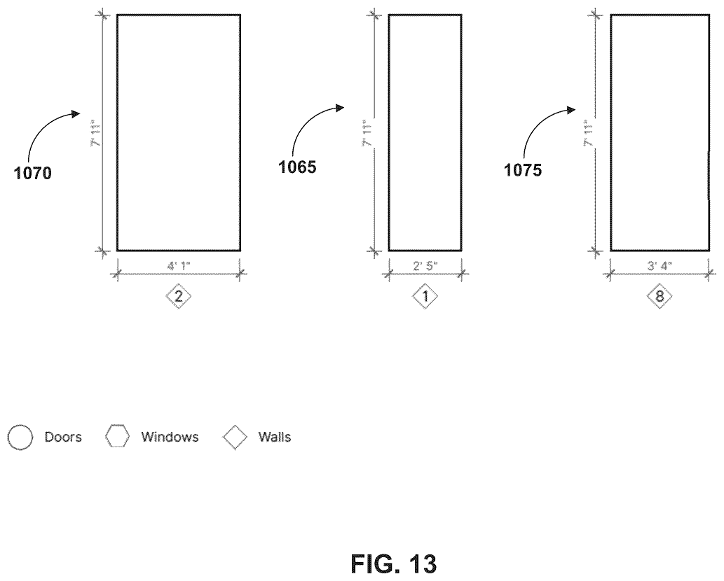

FIG. 12 illustrates wall detailed views of orthographic vector drawings 1040, 1045, 1050, 1055, and 1060 of Walls 3, 4, 5, 6, and 7 (also shown in FIGS. 10 and 11) and surfaces and/or contents, respectively. FIG. 13 illustrates wall detail views 1070, 1065, and 1075 of orthographic vector drawing of Walls 2, 1 and 8 (also shown in FIGS. 10 and 11), respectively. Generating these wall detail view orthographic vector drawings comprises extracting the key data items (e.g., walls, doors, windows, etc.), positioning a camera view of 3D representation looking at a wall of interest, and generating and rendering the wall detail view using the SVG two dimensional file format, based on the camera view, for output, i.e. via generating component 110 and rendering component 112. In FIGS. 12-13, example attributes are generated and provided (i.e., rendered) in the form of generated architectural annotations determined with the trained machine learning model and/or processing modules (as described herein) including dimensions, tags, and word labels associated with Walls 1-8, the door 1010, and window 1020; and areas associated with the walls, doors, and windows. For example, as shown in vector drawing 1045, the word label picture is included with the tag A and red hexagon for the window 1020. As another example, in vector drawing 1040, the word label Single Swing is included with the tag A and blue circle hexagon for the door 1010.

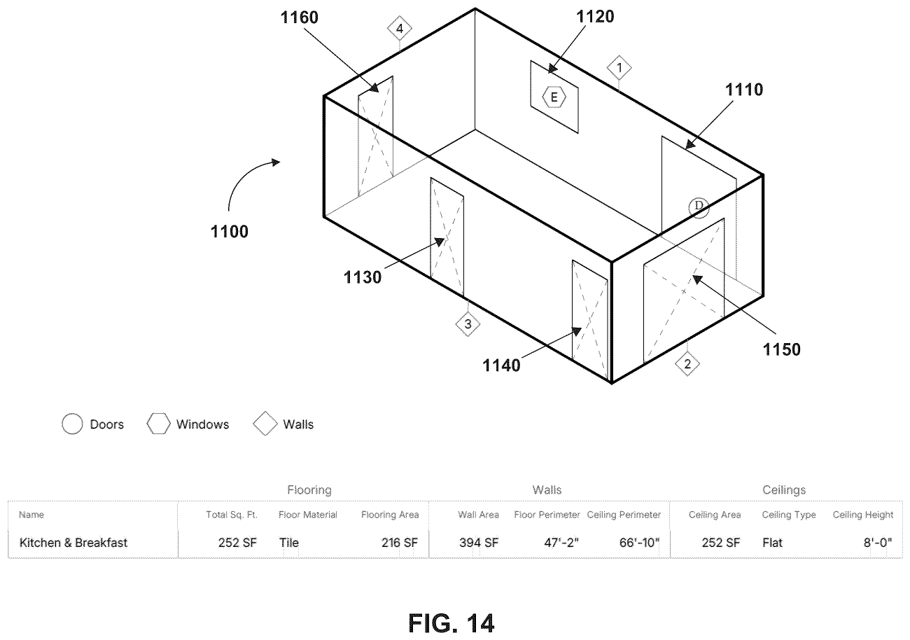

FIG. 14 illustrates yet another example three dimensional summary view isometric vector drawing 1100 of surfaces and contents in still a different physical scene, e.g., a multipurpose area including a kitchen and a breakfast room, in accordance with embodiments. That is, FIG. 14 shows a vector drawing of a multiroom or multi-purpose room that may be generated by the herein disclosed system and method, in accordance with embodiments. FIGS. 18 and 19 show example photographs 1300 and 1310, respectively, representing the kitchen and breakfast room that is used to capture input via a user computing platform 104 or other user device and processed to output vector drawings as described in FIGS. 14-17. For example, the user may use real time video capture and/or image capturing via the graphical user interface controlled by receiving component 108 and presented by computing platform 104 as previously described. FIG. 20 shows an example of an application platform, on computing platform 104, presenting the graphical user interface 1320 to the user, wherein the user is scanning items in the kitchen/room for identification and processing via the aforementioned processors and/or models. The one or more electronic models (e.g., a machine learning model) and/or processing components process the real time video/mage input to identify surfaces, contents, and/or structures, and prepare for output the 3D output model 1330 shown in FIG. 21. In embodiments, it is this 3D output model 1330-or 3D representation-of the physical scene (of FIGS. 18 and 19) that may be utilized for projecting the 3D representation in an isometric view (as shown in FIG. 14), and rendering the three dimensional summary view isometric vector drawing 1100 using a scalable vector graphics (SVG) two dimensional file format based on the projecting (e.g., see SVG component 112 shown in FIG. 1 and described above).

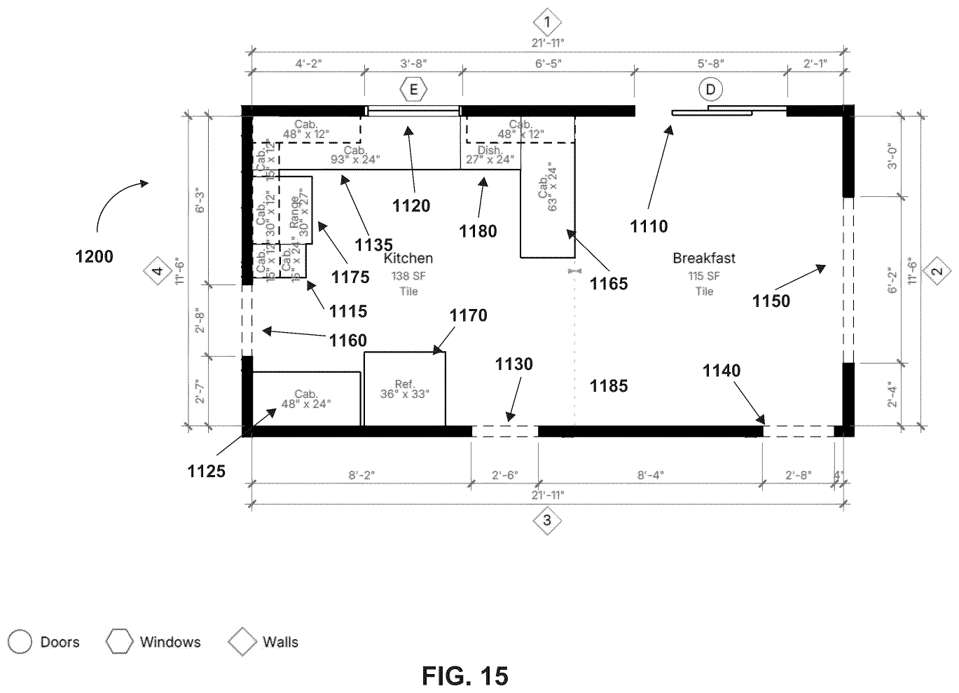

Turning back to FIG. 14, illustrated therein are several example attributes in form of architectural annotations determined with the trained machine learning model and/or processing modules (as described herein). FIGS. 15-17 further illustrate generations and renderings corresponding to the view of FIG. 14. In particular, FIGS. 14-17 include examples of labels in the form of letters and numbers (e.g., A, B, . . . . Z, and 1, 2, 3, . . . . N) (e.g., Doors, windows, and walls) as shown in the corresponding Key, identification tags in the form of shapes and/or colors (e.g., Blue Circle, Red Hexagon, Green Diamond, etc.) that correspond to particular surfaces and/or contents as defined by a generated Key (e.g., Doors, Windows, and Walls, etc. (respectively)), as well as dimensions in terms of feet, inches, and square footage. Specifically, shown in the isometric vector drawing 1100 are surfaces (Wall 1, Wall 2, Wall 3, and Wall 4, in this example, labeled with numbers 1-4 and green diamond shaped tags, respectively) in the physical scene of a kitchen. Generating the three dimensional summary view may comprise extracting key data items comprising walls (e.g., Walls 1-4), windows (e.g., window 1120, labeled with letter E and a red hexagon shaped tag), door (e.g., double sliding glass door 1110, labeled with the letter D and a blue circle shaped tag), and openings (e.g., openings 1130, 1140, 1150, and 1160) from a 3D representation (e.g. 1330 in FIG. 21) of a physical scene (e.g., kitchen and breakfast room), projecting the 3D representation in an isometric view (as shown in FIG. 14), and rendering the three dimensional summary view isometric vector drawing 1100 using a scalable vector graphics (SVG) two dimensional file format based on the projecting (e.g., see SVG component 112 shown in FIG. 1 and described above).

As noted above, in this example of FIG. 14, the attributes comprise dimensions and identification tags associated with Walls 1-4 (including sequential number tags of a green diamond), a ceiling, a floor or flooring, door 1110 (including the tag D in blue circle), window 1120 (including the tag E in a red hexagon), and openings 1130, 1140, 1150, and 1160 (including an internal dashed X to represent no structural element present in the corresponding wall). Specifically, FIG. 14 describes example room feature dimensions for floor area and total square feet, total wall area including floor perimeter, and ceiling area (for one example use case). Although not shown in FIG. 14, quantities of contents and/or detected cutouts (such as those examples shown in FIG. 4) may also be provided.

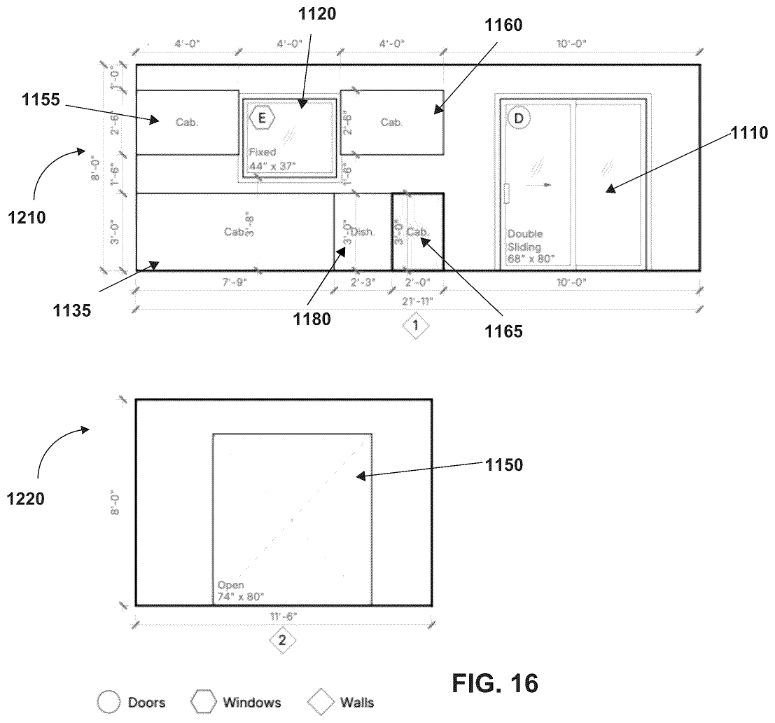

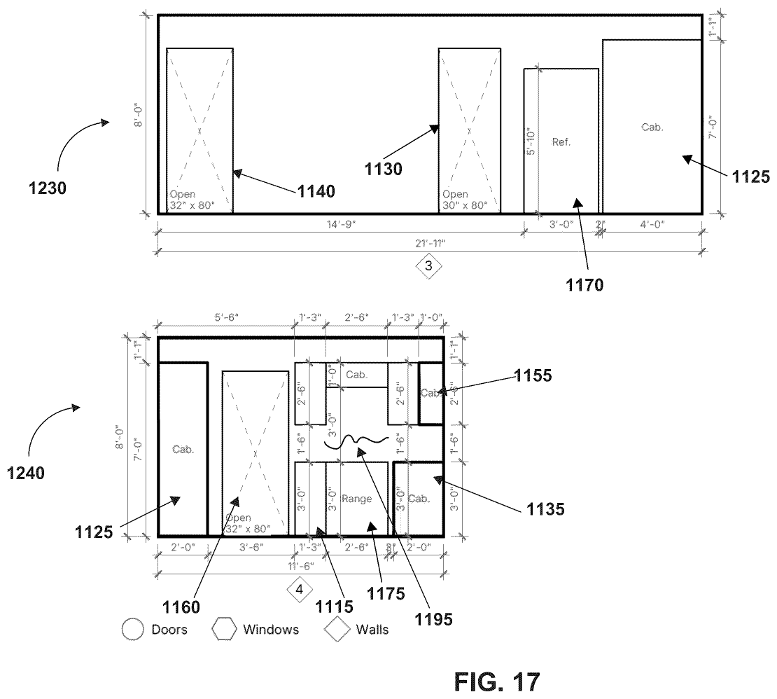

FIG. 15 illustrates an example of a two dimensional floorplan orthographic vector drawing 1200 of the surfaces of the physical scene corresponding to FIG. 14, in accordance with embodiments. Further, key data items of doors, windows, walls, and openings, as well as internal contents such as cabinets—are generated and rendered with architectural annotations based on a drawing scale of the drawings generated using the SVG two dimensional file format. Similar labels are used in the vector drawing 1200 of FIG. 15 as provided in FIG. 14. In addition, the vector drawing 1200 of FIG. 15 shows the multiroom includes an unwalled sub-room representing in the 2D floor plan; namely, a blue dotted or dashed line 1185 is provided to distinguish boundaries between the kitchen and breakfast room, for example. Generating the two dimensional floorplan may comprise extracting the key data items (e.g., Walls 1-4, door 1110, window 1120, openings 1130, 1140, 1150, and 1160, appliances (e.g., refrigerator 1170, range 1175, and dishwasher 1180), and cabinets 1115, 1125, 1135, 1165, in this example), projecting the three dimensional representation in a top down view (e.g., as shown in FIG. 15), and rendering the two dimensional floorplan using the SVG two dimensional file format based on the projecting. In FIG. 15, it should be noted that additional cabinets are represented in dashed lines to indicate, for example, mounting of a cabinet (e.g., cabinet 1160) on a wall that is above a floor mounted cabinet (e.g., cabinet 1165); such cabinets are generated and rendered and shown, for example, in the views of FIGS. 16-17. Example attributes are generated and provided (i.e., rendered) in FIG. 15 as previously described, e.g., architectural annotations determined with the trained machine learning model and/or processing modules (as described herein) and comprise dimensions and identification tags associated with Walls 1-4, the door 1110, window 1120, openings, etc. as described above. In addition to the labels and Key previously mentioned, additional word labels and/or abbreviations, e.g., Kitchen, Cabinet or Cab., Refrigerator or Ref., Range, Dishwasher or Fish., labeled with dimensions, may be generated.

FIG. 16 illustrates wall detailed views of orthographic vector drawings 1210 and 1220 of Walls 1 and 2 (also shown in FIGS. 14 and 15) and surfaces and/or contents, respectively. FIG. 17 illustrates wall detail views of orthographic vector drawings 1230 and 1240 of Walls 3 and 4 (also shown in FIGS. 14 and 15) and surfaces and/or contents, respectively. Generating these wall detail view orthographic vector drawings comprises extracting the key data items (e.g., walls, doors, windows, etc.), positioning a camera view of 3D representation looking at a wall of interest (see, e.g., the features in FIG. 19 which are obtained by looking and scanning as shown in FIG. 20), and generating and rendering the wall detail view using the SVG two dimensional file format based on the camera view (i.e., 3D representation, FIG. 21), for output, i.e. via generating component 110 and rendering component 112. In FIGS. 16-17, example attributes are generated and provided (i.e., rendered) in the form of generated architectural annotations determined with the trained machine learning model and/or processing modules (as described herein) including dimensions, tags, and word labels associated with Walls 1-4, the door 1110, window 1120, and openings 1130, 1140, 1150, and 1160, etc.; and areas and contents associated with the walls, doors, and windows. For example, as shown in vector drawing 1210, cabinets 1155, 1160, and 1165 and an appliance in the form of dishwasher 1180, in addition to cabinet 1135, are added to Wall 1. Word labels such as abbreviations for cabinet (e.g., Cab.), dishwasher (e.g., Dish) and sliding door (e.g., Sliding or Double Sliding) may be included with/on any of the tagged items (e.g., window 1120) or untagged items. The word label Fixed is included with the tag E and red hexagon for the window 1120. As another example, in vector drawing 1220, the word label Open along with a dashed X is included for the opening 1150 in Wall 2. FIG. 17 further illustrates in vector drawing 1230 refrigerator 1170 (Ref.) and cabinet 1125 with openings 1130 and 1140, labeled with abbreviations and dimensions. Vector drawing 1240 illustrates cabinets 1115, 1125, 1135, 1155 and a series or set 1195 of overhead cabinets along with range 1175, further labeled with abbreviations and dimensions.

As previously mentioned, distinctions may be made in generated and/or rendered output vector drawings in accordance with embodiments herein. One example that is illustrated in the embodiment represented by FIGS. 14-17 is providing distinctions between floor and wall elevations for surfaces and contents via solid and/or dashed lines. Generating and rendering lines of different weights, shading, and/or opacity, for example, allows for increased understanding and depictions of depth and elements in the generated drawings and as provided by the input images (e.g., from a camera). In embodiments, where two dimensional floorplan orthographic vector drawings are generated, such as shown by drawing 1200 in FIG. 15, because contents (such as cabinets) in a Y-direction of the room/kitchen are flattened by such views, then such elements/contents that may be on top of each other (e.g., in an elevation view), or below each other, may be carefully considered and possibly weighed to distinguish and thus illustrate presence and depth of such contents. As an example, contents (like cabinets 1155 and set 1195 of cabinets, which are shown in FIG. 17) may be rendered as shown by drawing 1200 in FIG. 15 with dashed or dotted lines to symbolize element(s) is/are above and/or below other contents and elements. In the depiction of FIG. 15, cabinets 1155 and set 1195 are not labeled but are shown in dashed lines to depict presence of such contents above solid lined cabinet 1135. In another example, in embodiments where orthographic vector drawings are generated showing wall elevations, such as vector drawing 1240 of Wall 4 in FIG. 17, because contents (such as cabinets) in a Z-direction and/or X-direction (depth) of the room/kitchen may be flattened by such views, then such elements/contents that may be in front or back of each other may be carefully considered and possibly weighed to distinguish and thus illustrate presence depth of such contents. As an example, contents (like cabinets 1135, 1125, 1115, 1155, and set 1195) may be rendered as shown by drawing 1240 with different line weights to symbolize element(s) is/are in front of and/or in back of other contents and elements. In the depiction of FIG. 17, cabinets 1125, 1135, and set 1155 are generated and rendered with relatively heavier solid line weights to depict a relatively closer depth (i.e., closer to the camera, or coming towards the camera) as compared to the line depths used to generate and render cabinets 1115 and set 1195 (which are farther away from the image/photo/camera, or behind other contents) in the Figure. In embodiments, shading or shaded boxes may be utilized to symbolize depth like front and/or back positions, relative to the camera/input image (see, e.g., cabinet 1165, in vector drawing 1210; cabinets 1125 and 1135 in vector drawing 1240). In embodiments, continuity of lines and the number of lines that are generated and rendered may be altered in order to provide clean images for each drawing that is generated.

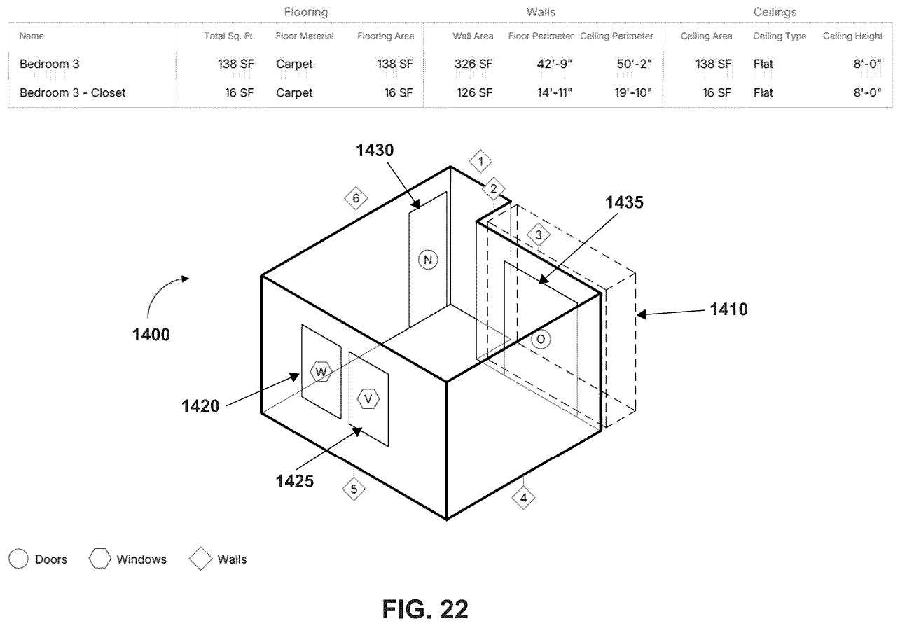

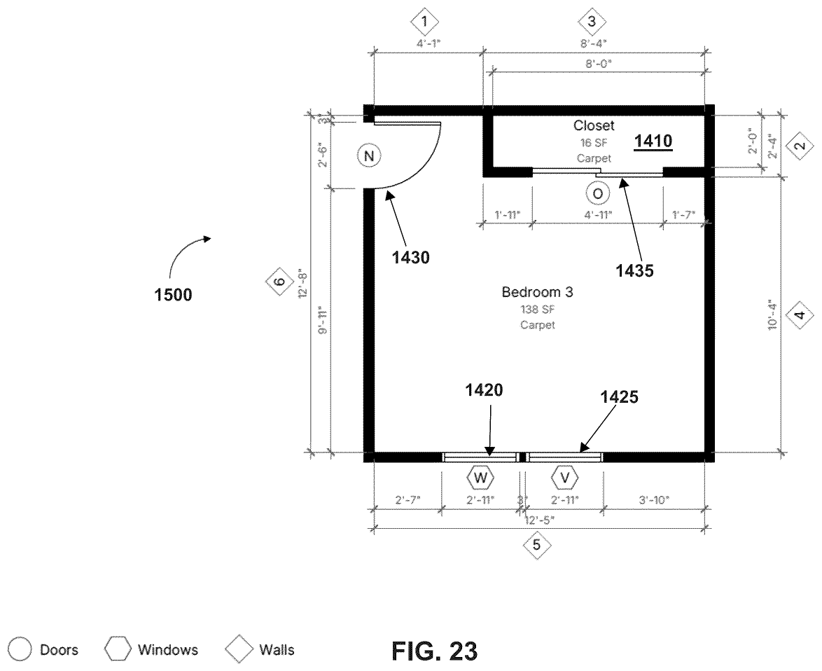

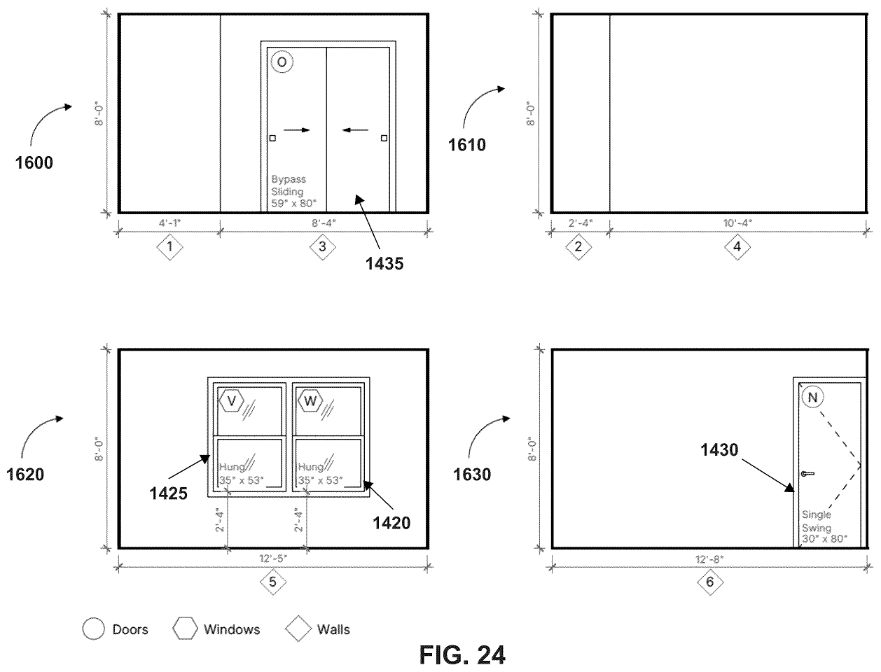

Turning now to FIGS. 22-24, an exemplary embodiment of isometric and/or orthographic vector drawings depicting a multiroom with a sub-room (e.g., closet) is shown that may be generated by the herein disclosed system and method. Much like FIGS. 10-13 and FIGS. 14-17, FIGS. 22-24 depict exemplary embodiments of generated and rendered isometric and orthographic vector drawings for the multiroom with sub-room. FIG. 22 illustrates still yet another example three dimensional summary view isometric vector drawing 1400 of surfaces and/or contents in still a different physical scene of the room providing sub-room 3D visualization, wherein attention is focused on the main room geometry while still getting a perception of wall thickness and general spatial awareness of the sub-room. Specifically, the model/isometric vector drawing 1400 shows a bedroom (parent) room in solid black lines, with a closet sub-room (child) in dotted or dashed lines 1410. Such visuals provide enhancements to the output drawing as well as additional information to the user. Also provided on the vector drawing 1400 of FIG. 22 are several example attributes in form of architectural annotations determined with the trained machine learning model and/or processing modules (as described herein) and/or processing modules. FIGS. 23-24 further illustrate generations and renderings corresponding to the view of FIG. 22. In particular, shown in the isometric vector drawing 1400 are surfaces (Wall 1, Wall 2, Wall 3, Wall 4, Wall 5, and Wall 6 in this example, labeled with numbers 1-6 and green diamond shaped tags, respectively) in the physical scene of a bedroom with a closet. Generating the three dimensional summary view may comprise extracting key data items comprising walls (e.g., Walls 1-6), windows (e.g., windows 1420 and 1425, labeled with letters W and V respectively and a red hexagon shaped tag), door (e.g., door 1430, labeled with the letter N and a blue circle shaped tag), and openings or doors (e.g., door 1435 for the closet, labeled with letter O and a blue circle shaped tag) from a 3D representation of the physical scene (not shown), projecting the 3D representation in an isometric view, and rendering the three dimensional summary view isometric vector drawing 1400 using a scalable vector graphics (SVG) two dimensional file format based on the projecting (e.g., see SVG component 112 shown in FIG. 1 and described above). FIG. 22 also describes example room feature dimensions for floor area and total square feet, floor material (e.g., carpet), total wall area including floor perimeter, ceiling perimeter, and ceiling area with ceiling type (e.g., flat) and ceiling height) (for one example use case). Although not shown in FIG. 22, quantities of contents and/or detected cutouts (such as those examples shown in FIG. 4) may also be provided.

FIG. 23 illustrates an example of a two dimensional floorplan orthographic vector

drawing 1500 of the surfaces of the physical scene corresponding to FIG. 22, in accordance with embodiments. Further, key data items of doors, windows, walls, and openings, as well as sub-room of a closet-are generated and rendered with architectural annotations based on a drawing scale of the drawings generated using the SVG two dimensional file format. Similar labels are used in the vector drawing 1500 of FIG. 23 as provided in FIG. 22. In addition, the vector drawing 1500 of FIG. 23 shows that the sub-room represented in the 2D floor plan is a walled sub-room including internal walls; namely, word label of Closet and dimensions are added (at right) to show thickness of the walls for the sub-room, for example. In addition, doors such as closet doors are also depicted. Generating the two dimensional floorplan may comprise extracting the key data items (e.g., Walls 1-6, doors 1430, 1435, windows 1420, 1425, internal walls, etc., projecting the three dimensional representation in a top down view (e.g., as shown in FIG. 23), and rendering the two dimensional floorplan using the SVG two dimensional file format based on the projecting. Example attributes are generated and provided (i.e., rendered) in FIG. 23 as previously described, e.g., architectural annotations determined with the trained machine learning model and/or processing modules (as described herein) and comprise dimensions and identification tags as described above. In addition to the labels and Key previously mentioned, additional word labels and/or abbreviations, e.g., Bedroom 3, carpet, Closet, may be generated.

FIG. 24 illustrates wall detailed views of orthographic vector drawings 1600, 1620, 1620, and 1630 of Walls 1-6 (shown in FIGS. 22 and 23) and surfaces and/or contents, respectively. FIG. 24 includes an embodiment in accordance with the disclosure wherein the system and method is configured to generate drawings in the form of wall elevation “groups,” wherein walls are combined when generated and output. For example, FIG. 24 shows in orthographic vector drawing 1600 a combination of wall 1 and wall 3 in one image, as the normal of each wall (the way the wall faces) is the same direction. Similarly, orthographic vector drawing 1610 shows a combination of wall 2 and 4. Accordingly, depicting wall elevation groups allows for simplification of output drawings/graphics with a single view, showing the perspective of the wall regardless of depth and giving a true representation of how the walls would look when standing away therefrom and looking directly at the walls. Generating these wall detail view orthographic vector drawings comprises extracting the key data items (e.g., walls, doors, windows, etc.), positioning a camera view of 3D representation looking at a wall of interest, and generating and rendering the wall detail view using the SVG two dimensional file format based on the camera view, for output, i.e. via generating component 110 and rendering component 112. In FIG. 24, example attributes are generated and provided (i.e., rendered) in the form of generated architectural annotations determined with the trained machine learning model and/or processing modules (as described herein) including dimensions, tags, and word labels associated with Walls 1-6, the doors 1430, 1435, etc. as previously described, etc. For example, as shown in vector drawing 1600, door 1435 is added to Wall 3. Word labels such as door type (e.g., Bypass Sliding) may be included with/on any of the tagged items or untagged items. The word label Hung is included with the tags V and W and red hexagons for the windows 1425 and 1420. As another example, in vector drawing 1630, the word label Single Swing along with a dashed sideways V is included with tag N for the door 1430 in Wall 6. Orthographic vector drawings 1600, 1620, 1620, and 1630 are further labeled with dimensions.

As previously mentioned, distinctions may be made in generated and/or rendered output vector drawings including generating and rendering lines of different weights, shading, and/or opacity, for example, as should be understood and thus not repeated again here.

Based on these illustrated embodiments, then, this disclosure provides a system and method for automatically generating vector-based room floor plans-that include associated sub-rooms such as closets-with comprehensive architectural annotations, including tags, labels, and dimension lines, as illustrated and described previously above. Additionally, this disclosure also provides system and method for automatically generating vector-based interior wall elevation views with comprehensive architectural annotations, including tags, labels, and dimension lines. In embodiments, when generating either such vector-based room floor plans and/or generating vector-based interior wall elevation views, to ensure maximum legibility of dimension lines on any room configuration (in vector-based floor plans) and/or wall configuration (in vector-based all elevation views), certain dimensions may be rendered depending on the drawing scale, which is automatically set from a list of standardized scales to optimize the drawing layout on a pre-specified page size.

Additionally, in embodiments, attributes/annotations are configured to be rendered in a hierarchy with at least two tiers comprising inner tiers and an outer tiers. In an example, dimensions on generating drawings are configured to be rendered in a hierarchy with at least two tiers, i.e., inner tiers and an outer tiers, as previously described. Rules or guidelines regarding addition of tiers (or use of tiers like inner tiers and outer tiers) may be considered. Further, placement of attributes/annotations (such as tags) may be generated and rendered based another attributes/annotations (e.g., in view of dimensions) or relative to a predefined or predetermined point (e.g., center-point) of extracted key data items. As an example, tags for walls may be rendered (by SVG component 112) outside of the dimensions and/or wall elevations. Again, line weights and/or opacity thereof may also be adjusted.

To further demonstrate such features, the Examples below describe scenarios wherein hierarchies and rules are utilized and applied by the disclosed system 100 for generating and/or rendering the isometric and/or orthographic vector drawings using SVG described herein.

### EXAMPLES

### Example 1

This example refers to a system and method for automatically generating vector-based room floor plans-that include associated sub-rooms such as closets—with comprehensive architectural annotations, including tags, labels, and dimension lines. In this particular example, for a typical 1/4″=1′-0″ scale room plan:
a. Dimensions will be rendered in a hierarchy with two tiers.
i. Outer tiers indicate the overall length of each wall segment. Dimensions will be automatically co-aligned in a single string for wall segments whose normal vectors intersect.
1. Non-perpendicular walls will receive an additional dimension line parallel to that wall.
ii. Inner tiers are only added if a wall has an opening, door or window, in which case the outer tier shall be offset an additional distance from the room boundary. The inner tier indicates the position and width of each opening, door or window along that wall in a single continuous dimension string, including space between any openings and the edges of the wall.
iii. The first tier of dimensions is offset 1′-9″ from the bottom and right of the floor plan's overall bounding box, and offset 1′-3″ from the top and left. If needed, a second tier is offset 9″ out from the inner tier.
iv. If a walled sub-room or closet is present, the opening dimension string associated with that sub-room is offset 1′-9″ inside the parent room. To avoid overlap, only wall lengths for the sub-room that are on the perimeter of the bounding box are shown and are rendered outside the room at the inner tier location.
v. Fixture lengths and widths are indicated in text as part of the fixture labels, but fixture locations are dimensioned on the wall elevations.

To ensure clarity for wall labeling of such generated vector-based room floor plan, as a reference for wall elevation views:
b. Wall tags are rendered outside of the floor plan extents directly adjacent and centered outside of their associated dimension line. Symbol and text are oriented parallel to the wall, and matching the dimension.

To ensure maximum legibility on door and window tags of such generated vector-based room floor plan:
c. Door tags are rendered in different positions depending on the identified door sub-type. Offset distances vary and are automatically adjusted depending on the drawing scale.
i. Tags for single swing doors are centered in the wall opening
ii. Tags for double swing doors are centered in the opening width and offset towards inswing side
iii. Tags for double sliding or bifold doors are centered in the opening width and:
1. Offset towards the parent room if wall is shared with a sub-room
2. Offset towards the exterior if wall is not shared
d. Window tags are rendered in the center of the opening width and offset towards the exterior.
i. If windows are adjoining and share an edge, tags will automatically be placed end to end to avoid overlapping, and be centered across the combined opening width.

To ensure maximum legibility on fixture annotations of such generated vector-based room floor plan:
e. Labels for permanent fixtures like cabinetry, fireplaces, plumbing fixtures and appliances are centered in the fixture's footprint and oriented parallel to the longest edge. Some exceptions are specified to minimize overlap in rooms with many fixtures that are often stacked vertically, such as kitchens:
i. For cabinets, dishwashers and ranges, tags shall always be oriented parallel to the wall they are touching against regardless of the fixture's proportion.
1. For base cabinets, dishwasher and ranges, tags shall stay centered in width but be offset towards edge away from wall to minimize overlap in case of upper cabinet labels.

### Example 2

This example refers to a system and method for automatically generating vector-based interior wall elevation views with comprehensive architectural annotations, including tags, labels, and dimension lines. In this particular example, for typical 1/4″=1′-0″ scale wall elevations:
a. Dimensions will be rendered in a hierarchy with two tiers, plus additional interior vertical dimensions as noted below.
i. Outer tiers indicate the overall length and height(s) of each wall segment.
1. If a wall has a single consistent height, vertical height dimension is only shown once on the left edge.
2. If a wall varies in height on either end, vertical height dimensions are shown on left and right edges, plus additional co-aligned dimensions are shown to indicate the vertical height differential up to any higher ceiling peaks in the middle of the wall.
ii. Inner tiers are only added if a wall has permanent fixtures attached to it, in which case the outer tier shall be offset an additional distance from the wall outline.
1. The horizontal inner tier(s) indicates the position and width of each fixture against that wall in a single continuous dimension string, including space between any fixtures and the left and right edges of the wall.

A. Fixture width dimensions are shown at either the bottom or top depending on whether they are closest in proximity to the top or bottom of the wall. If the fixture is equidistant or is touching both the floor and the ceiling, width should be shown on the bottom only.
If there are more than 2 fixtures stacked vertically, only include width dimensions for the fixtures closest to the floor and ceiling, and omit width measurements for any intermediate fixtures.
2. The vertical inner tier(s) indicate the position and height of each fixture touching or within 9″ of the left or right wall edge in a single continuous dimension string, including space between any fixtures and the top and bottom of the wall.
iii. The first tier of dimensions is offset 9″ from the bottom and right edges of wall outline, and 6″ from the top and left. If needed, a second tier is offset 9″ out from the inner tier.
iv. Interior vertical dimensions are shown to indicate sill heights of all openings, and heights of any intermediate fixtures not within 9″ of either wall edge. This includes the height of all fixtures themselves as well as the distance from their bottom edges to the floor, if applicable. The distance of a fixture to the floor will be divided into multiple measurements to indicate the height of any other fixtures located below it, if applicable.
1. Interior vertical dimensions are located 6″ inset to the right, from the leftmost edge of the fixture or opening.
2. If there are multiple fixtures stacked vertically in the same space, height dimensions are co-aligned into a single dimension string. Even if the fixtures are not precisely aligned, the dimension is intelligently placed based on the left edge that is farthest to the right.
v. Wall opening lengths and widths are indicated in text as part of the opening labels, but opening locations are dimensioned on the floor plans.

To ensure clarity for wall labeling of such generated vector-based interior wall elevation views, to correspond with floor plans and isometric views:
b. Wall tags are rendered outside of the wall elevation extents directly adjacent and centered below their associated dimension line.

To ensure maximum legibility on wall opening of such generated vector-based interior wall elevation views, door and window annotations:
c. Door and window tags are rendered in the top left corner of the opening.
d. Wall opening labels are rendered in the bottom left corner of the opening.

To ensure maximum legibility on fixture annotations of such generated vector-based interior wall elevation views:
e. Fixture labels include fixture type abbreviation only, and no size dimensions.
f. To avoid overlap with interior vertical dimensions, fixture labels are omitted for fixtures less than a minimum width that are not within a minimum distance of the left or right wall edge, such that their height dimension would be shown as part of the inner tier. The minimum measurements vary and are automatically adjusted depending on the drawing scale.

### Example 3

This example refers to a system and method for automatically generating isometric projections of interior rooms that follow architectural graphic standards for representation. This includes dynamic tags that maintain consistent sizing with scaled floor plans and wall elevations, regardless of the 3D view scale-which adjusts to fit the designated page space.

To maximize legibility of the 3D geometry of generated isometric projections of interior rooms:
a. Edges are automatically rendered with varying line-weights to give depth to the drawing.
i. All front facing walls are rendered with a heavy outline.
ii. Top edge of all walls is rendered with a heavy line.
iii. All other wall edges and wall opening outlines are rendered with a medium line.
b. Lines are automatically rendered with varying opacity to give depth to the drawing.
i. Visible lines that are not obscured behind other wall planes are shown black
ii. Hidden lines obscured behind other wall planes remain visible to fully convey the 3D space, but are shown in gray. The more wall planes obscuring the edge, the lighter the line will appear.

To ensure clarity for wall labeling of such generated isometric projections of interior rooms, as a reference for wall elevation views:
c. On front facing walls, wall tags are rendered below the bottom edge of the wall, connected to the wall segment center-point via a short leader line.
d. On back facing walls, wall tags are rendered above the top edge of the wall, connected to the wall segment center-point via a short leader line.

To ensure maximum legibility on door and window labels of such generated isometric projections of interior rooms:
e. Door and window tags are rendered at the center-point of the opening.

Each of the above Examples and details herein thus provide generation of one or more isometric and/or orthographic vector drawings using SVG from received description data (e.g., images from a camera or device) of a physical scene at a location, wherein the SVG drawings are 100% if not infinitely scalable vector graphics drawn with accurate scale and without loss of readability and/or blurring during scaling. In embodiments, logics may be utilized to change the scale of the drawings dependent upon dimensions, e.g., the width and length, of a room/wall or physical scene.

Further, in accordance with embodiments, it should be understood that the

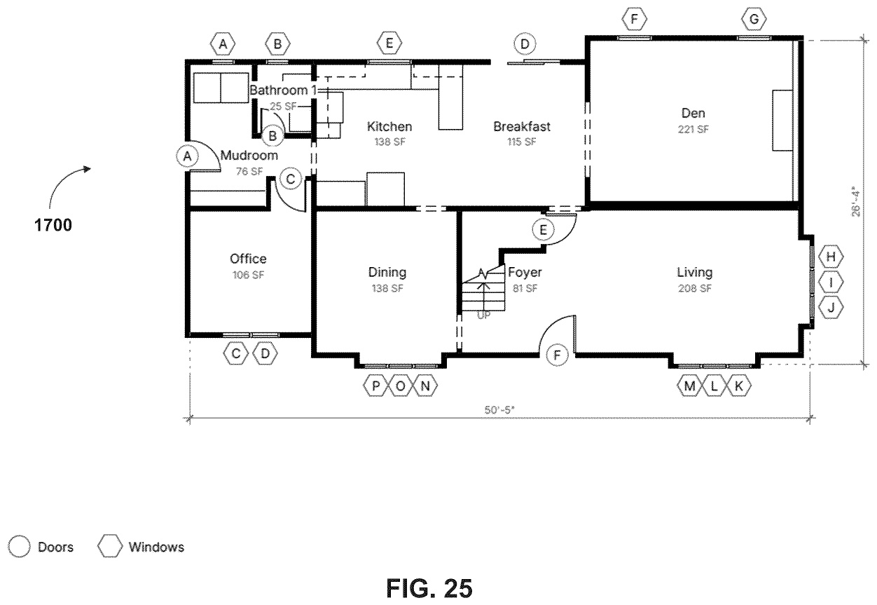

aforementioned examples of rooms and vector drawings may be aggregated and/or stitched-together to form a full floor plan view, which is shown and represented in FIG. 25. FIG. 25 illustrates an example of a two dimensional floorplan orthographic vector drawing 1700 of multiple rooms associated with a physical scene of a location, e.g., rooms throughout a floor of a house, in accordance with embodiments. Further, key data items of doors, windows, walls, and openings, etc.—are generated and rendered with architectural annotations based on a drawing scale of the drawings generated using the SVG two dimensional file format. For example, the multiroom of the kitchen and breakfast room shown in FIG. 15 (as well as FIGS. 14 and 16-17) is included in the vector drawing 1700. Similar labels may be used in the vector drawing 1700 of FIG. 25 as provided throughout the individual vector drawings (e.g., vector drawing 1200 of FIG. 15) of the rooms. That is, in accordance with embodiments, when generating a two dimensional floorplan orthographic vector drawing to depict more than one room and/or multiple rooms as provided in FIG. 25, to simplify and optimize legibility, measurements may be limited in the generated 2D floorplan—e.g., to overall bounding box dimensions of the floor. Individual room floor plans (like those shown in FIGS. 14-17), however, may be generated and rendered to contain wall by wall measurements and further details regarding the surfaces and/or contents in that particular room. Returning to FIG. 1, in some embodiments, a graphical user interface may be provided for displaying and interacting with the interactive 3D representation of the physical scene and its associated information. The graphical user interface may be presented in a browser or on an app running on a user computing platform 104, for example. The graphical user interface provides multiple capabilities for users to view, edit, augment, and otherwise modify the 3D representation and its associated information, and/or the vector drawings described herein. The graphical user interface enables additional information to be spatially associated within the context of the 3D representation and/or the vector drawings. This additional information may be in the form of semantic or instance annotations; 3D shapes such as parametric primitives including, but not limited to, cuboids, spheres, cylinders and CAD models; and audio, visual, or natural language notes, annotations, and comments or replies thereto. The graphical user interface further enables a user to review previously captured scenes, merge captured scenes, add new images and videos to a scene, and mark out a floorplan of a scene, among other capabilities.

Accordingly, it should be understood that computing platform(s) 104 may be used for input, used for output (e.g., display), or both input and output. As described throughout, computing platform(s) 104 may be a physical computing device that includes a user interface which is viewable by a user, and, in some cases, interactive for input, output, and/or editing. For example, a user interface may include a touch screen and/or keyboard. Generations and/or renderings of the disclosed isometric and/or orthographic vector drawings may be output via physically displacing on a physical computing device and editable by a user via user interaction with the physical computing device. In addition, generations and/or renderings of the disclosed isometric and/or orthographic vector drawings may be updated in real-time and configured for display on the physical computing device. In some embodiments, generations, renderings, and/or updates may be stored in a storage device on the physical computing device.

Also, the type of output of the generated one or more isometric and/or orthographic vector drawings of the surfaces and/or contents in the physical scene based on the three dimensional representation as described and shown throughout this disclosure and represented in FIGS. 4-17 and 22-25 should not be limited. As mentioned above, in embodiments, output may be to a user interface, e.g., on a display, of computing platform 104 or other user device. Other outputs may include, but are not limited to, electronic documents, printed documents (e.g., via a printer), a file saved in electronic storage 126, and the like.

Distance, perimeter, and area measurements can be changed to metric instead of imperial or potentially integers and quarter units instead of decimals, depending on the user's selected preference, for example. Annotations and notes for one or more drawings can be recorded. Example notes may include notes related to wall type (paneled, drywall, other), paint type, wall integrity (smooth, imperfect, damaged), etc. In some embodiments, other characteristics of a wall can be marked on a drawing such as location of studs, wall mounted televisions, location of communication ports (coaxial, telephone, ethernet), etc. In some embodiments, other items of note can be marked on a drawing such as: openings (e.g. windows, doors, thresholds, pass-throughs), electrical (e.g. outlets, switches, junction boxes), plumbing (e.g. faucets, pipes, toilet, shower, hose bibbs), thermostats, skylights, ceiling fans, recessed lighting, chandeliers, smoke or carbon monoxide detectors, home alarm systems, doorbells, vents, and/or other features.

In some embodiments, SVG component 112 (FIG. 1) may be configured such that isometric and/or orthographic vector drawings generated by system 100 (FIG. 1) can be exported both to external applications for further analysis and work, as well as to a downloadable report for documentation and future use.

In the following, further features, characteristics, and exemplary technical solutions of the present disclosure will be described in terms of items that may be optionally claimed in any combination:
1. A non-transitory computer readable medium having instructions thereon, the instructions configured to cause a computer to perform operations comprising: receiving description data of a physical scene at a location, generating, with a trained machine learning model, an electronic virtual three dimensional representation of the physical scene based on the description data, the three dimensional representation comprising data items corresponding to surfaces and/or contents in the physical scene; and generating one or more isometric and/or orthographic vector drawings of the surfaces and/or contents in the physical scene based on the three dimensional representation.
2. The medium of item 1, wherein the one or more isometric and/or orthographic vector drawings are generated using a scalable vector graphics (SVG) two dimensional file format.
3. The medium of any of the previous items, wherein generating the one or more isometric and/or orthographic vector drawings comprises sorting the data items based on their locations in the three dimensional representation of the physical scene at the location, and rendering the one or more isometric and/or orthographic vector drawings back to front, starting with surfaces and/or contents that are farthest from a view location for the one or more isometric and/or orthographic vector drawings.
4. The medium of any of the previous items, wherein generating the one or more isometric and/or orthographic vector drawings using SVG, back to front in the physical scene at the location, facilitates infinite scaling of the one or more isometric and/or orthographic vector drawings without appreciable without appreciable blurring.
5. The medium of any of the previous items, wherein the one or more isometric and/or orthographic vector drawings are generated in real time responsive to the computer receiving user input requesting generation.
6. The medium of any of the previous items, wherein the surfaces and/or contents in the physical scene comprise walls, a ceiling, a floor, a window, a door, a countertop, a cabinet, and/or a permanent fixture.
7. The medium of any of the previous items, wherein the one or more isometric and/or orthographic vector drawings of the surfaces and/or contents in the physical scene comprise a three dimensional summary view, a two dimensional floorplan, and/or a wall detail view.
8. The medium of any of the previous items, wherein the one or more isometric and/or orthographic vector drawings of the surfaces and/or contents in the physical scene comprise the three dimensional summary view, and wherein generating the three dimensional summary view comprises extracting key data items comprising walls, windows, and/or doors from the three dimensional representation of the physical scene, projecting the three dimensional representation in an isometric view, and rendering the three dimensional summary view using a scalable vector graphics (SVG) two dimensional file format based on the projecting.
9. The medium of any of the previous items, wherein the one or more isometric and/or orthographic vector drawings of the surfaces and/or contents in the physical scene comprise the two dimensional floorplan, and wherein generating the two dimensional floorplan comprises extracting key data items comprising walls, windows, and/or doors from the three dimensional representation of the physical scene, projecting the three dimensional representation in a top down view, and rendering the two dimensional floorplan using a scalable vector graphics (SVG) two dimensional file format based on the projecting.
10. The medium of any of the previous items, wherein the one or more isometric and/or orthographic vector drawings of the surfaces and/or contents in the physical scene comprise the wall detail view, and wherein generating the wall detail view comprises extracting key data items comprising walls, windows, and/or doors from the three dimensional representation of the physical scene, positioning a camera view of the three dimensional representation looking at a wall of interest, and generating and rendering the wall detail view using a scalable vector graphics (SVG) two dimensional file format, based on the camera view, for output, i.e. via generating component 110 and rendering component 112.
11. The medium of any of the previous items, wherein the description data comprises one or more images of the physical scene, and the one or more images are generated via a camera associated with a user.
12. The medium of any of the previous items, wherein the description data is generated via at least one of a camera, a user interface, an environment sensor, and an external location information database, the description data comprising one or more images of the physical scene.
13. The medium of any of the previous items, wherein the description data comprises one or more media types, the one or more media types comprising at least one or more of video data, image data, audio data, text data, user interface/display data, and/or sensor data, and wherein receiving description data comprises receiving one or more images from a camera and/or sensor data from one or more environment sensors, the one or more environment sensors comprising at least one of a GPS, an accelerometer, a gyroscope, a barometer, or a microphone.
14. The medium of any of the previous items, wherein the three dimensional representation comprises a textured or untextured three-dimensional mesh with vertices connected by edges, defining triangular or quadrilateral planar faces, wherein the vertices and the faces each separately comprise position, color, and/or surface normal information.
15. The medium of any of the previous items, wherein the three dimensional representation of the physical scene is stored as a triangle mesh, which comprises a graph data structure storing lists of vertices and a list of indices that indicate which vertices are joined together as a triangle, with each vertex comprising attributes including a position, a color, a normal vector, a parametrization coordinate, an instance index and a semantic class index; and wherein generating the three dimensional representation of the physical scene based on the description data comprises transferring detections of physical scene structures indicated by the data items to the three dimensional representation by: predicting, with the trained machine learning model, semantic classes for two dimensional input video frames included in the description data, projecting mesh vertices onto a camera image plane to map each of the mesh's vertices to image coordinates and determine a predicted label; determining whether a projected mesh vertex falls into a region labeled as a floor, wall, or ceiling; and determining a per mesh triangle label, where a triangle is labeled as part of the floor, wall, or ceiling if all of its adjacent vertices are labeled as floor, wall, or ceiling.
16. The medium of any of the previous items, the operations further comprising extracting the data items by providing the description data as input to the trained machine learning model to identify the data items, wherein the trained machine learning model comprises a convolutional neural network (CNN) and is trained to identify objects and structures in multiple physical scenes as the data items.
17. The medium of any of the previous items, wherein the machine learning model is trained with training data, the training data comprising input output training pairs associated with each potential data item.
18. The medium of any of the previous items, wherein the machine learning model is trained by: obtaining physical scene data associated with a specified physical scene at the location, wherein the physical scene data includes an image, a video or a three dimensional digital model associated with the specified physical scene; and training the machine learning model with the physical scene data to predict a specified set of surfaces and/or contents in the specified physical scene such that a cost function that is indicative of a difference between a reference set of surfaces and/or contents and the specified set of contents is minimized, wherein the trained machine learning model is configured to predict spatial localization data of the data items, the spatial localization data corresponding to location information of the surfaces and/or contents in the physical scene.
19. The medium of any of the previous items, the operations further comprising determining the attributes of the data items with the trained machine learning model, the attributes comprising dimensions and/or locations of the surfaces and/or contents.
20. The medium of any of the previous items, further comprising generating architectural annotations for the surfaces and/or contents of the generated one or more isometric and/or orthographic vector drawings, the generated architectural annotations comprising one or more of a label, identification tags, and dimensions, and rendering the generated one or more isometric and/or orthographic vector drawings with the generated architectural annotations based on a drawing scale of the drawings generated using the scalable vector graphics (SVG) two dimensional file format.
21. The medium of any of the previous items, further comprising generating architectural annotations for each of the extracted key data items, the generated architectural annotations comprising one or more of a label, identification tags, and dimensions, and updating the rendered three dimensional summary view with the generated architectural annotations.
22. The medium of any of the previous items, wherein the generated architectural annotations includes dimensions, and wherein the dimensions are configured to be rendered in a hierarchy with at least two tiers comprising inner tiers and an outer tiers, the inner tiers indicating applicable position and width of each window, door, and/or opening within the walls, and the outer tiers indicating at least an overall length of each wall segment of the walls, each wall having a wall elevation associated therewith.
23. The medium of any of the previous items, wherein the outer tiers further indicate a height of each wall segment.
24. The medium of any of the previous items, wherein the inner tiers are only added if (a) a wall segment of the walls has an opening, door and/or window, and/or (b) a wall segment of the walls has permanent fixtures attached thereto, and wherein the outer tiers are configured to offset an additional distance from wall outlines indicated in the inner tiers.
25. The medium of any of the previous items, wherein the generated architectural annotations further includes tags, wherein the dimensions are configured to be offset by a predetermined measurement range from wall outlines of the walls and wherein the tags for the walls are rendered outside of the dimensions and/or wall elevations.
26. The medium of any of the previous items, further comprising generating architectural annotations for each of the extracted key data items and generating isometric projections of interior rooms as part of the drawings, the generated architectural annotations comprising one or more of a label, identification tags, and dimensions, updating the rendered two dimensional floorplan with the generated architectural annotations, and rendering edges and lines of varying line-weight and/or opacity to provide depth.
27. The medium of any of the previous items, wherein the generated architectural annotations includes dynamic tags that maintain consistent sizing with scaled floor plans and wall elevations of the two dimensional floorplan, and wherein the tags for the walls, windows, and/or doors are rendered relative to a predefined center-point on the extracted key data items.
20. The medium of any of the previous items, the operations further comprising determining point to point measurements in the three dimensional representation, determining area measurements of one or more data items, and/or receiving user annotations related to one or more of the data items, and generating the one or more isometric and/or orthographic vector drawings based on the point to point measurements, the area measurements, and/or the user annotations.
21. A method comprising one or more of the operations recited in any of the previous items.
22.A system comprising one or more processors configured to perform one or more of the operations recited in any of the previous items.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network.

The relationship of client and server arises by virtue of computer programs running on the respective computers and having a client-server relationship with each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and sub combinations of the disclosed features and/or combinations and sub combinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

1. A non-transitory computer readable medium having instructions thereon, the instructions configured to cause a computer to perform operations comprising:
receiving description data of a physical scene at a location,
generating, with a trained machine learning model, an electronic virtual three dimensional representation of the physical scene based on the description data, the three dimensional representation comprising data items corresponding to surfaces and/or contents in the physical scene; and
generating one or more isometric and/or orthographic vector drawings of the surfaces and/or contents in the physical scene based on the three dimensional representation.

2. The medium of claim 1, wherein the one or more isometric and/or orthographic vector drawings are generated using a scalable vector graphics (SVG) two dimensional file format.

3. The medium of claim 2, wherein generating the one or more isometric and/or orthographic vector drawings comprises sorting the data items based on their locations in the three dimensional representation of the physical scene at the location, and rendering the one or more isometric and/or orthographic vector drawings back to front, starting with surfaces and/or contents that are farthest from a view location for the one or more isometric and/or orthographic vector drawings.

4. The medium of claim 3, wherein generating the one or more isometric and/or orthographic vector drawings using SVG, back to front in the physical scene at the location, facilitates infinite scaling of the one or more isometric and/or orthographic vector drawings without appreciable without appreciable blurring.

5. The medium of claim 1, wherein the one or more isometric and/or orthographic vector drawings are generated in real time responsive to the computer receiving user input requesting generation.

6. The medium of claim 1, wherein the surfaces and/or contents in the physical scene may comprise walls, a ceiling, a floor, a window, a door, a wall opening, a support column, a household appliance, a countertop, a cabinet, a permanent fixture, a staircase, a toilet, a bathtub, a fireplace, and/or a type of flooring.

7. The medium of claim 1, wherein the one or more isometric and/or orthographic vector drawings of the surfaces and/or contents in the physical scene comprise a three dimensional summary view, a two dimensional floorplan, and/or a wall detail view.

8. The medium of claim 7, wherein the one or more isometric and/or orthographic vector drawings of the surfaces and/or contents in the physical scene comprise the three dimensional summary view, and wherein generating the three dimensional summary view comprises extracting key data items comprising walls, windows, and/or doors from the three dimensional representation of the physical scene, projecting the three dimensional representation in an isometric view, and rendering the three dimensional summary view using a scalable vector graphics (SVG) two dimensional file format based on the projecting.

9. The medium of claim 7, wherein the one or more isometric and/or orthographic vector drawings of the surfaces and/or contents in the physical scene comprise the two dimensional floorplan, and wherein generating the two dimensional floorplan comprises extracting key data items comprising walls, windows, and/or doors from the three dimensional representation of the physical scene, projecting the three dimensional representation in a top down view, and rendering the two dimensional floorplan using a scalable vector graphics (SVG) two dimensional file format based on the projecting.

10. The medium of claim 2, further comprising
generating architectural annotations for the surfaces and/or contents of the generated one or more isometric and/or orthographic vector drawings, the generated architectural annotations comprising one or more of a label, identification tags, and dimensions, and
rendering the generated one or more isometric and/or orthographic vector drawings with the generated architectural annotations based on a drawing scale of the drawings generated using the scalable vector graphics (SVG) two dimensional file format.

11. The medium of claim 8, further comprising generating architectural annotations for each of the extracted key data items, the generated architectural annotations comprising one or more of a label, identification tags, and dimensions, and updating the rendered three dimensional summary view with the generated architectural annotations.

12. The medium of claim 11, wherein the generated architectural annotations includes dimensions, and wherein the dimensions are configured to be rendered in a hierarchy with at least two tiers comprising inner tiers and an outer tiers, the inner tiers indicating applicable position and width of each window, door, and/or opening within the walls, and the outer tiers indicating at least an overall length of each wall segment of the walls, each wall having a wall elevation associated therewith.

13. The medium of claim 12, wherein the outer tiers further indicate a height of each wall segment.

14. The medium of claim 12, wherein the inner tiers are only added if (a) a wall segment of the walls has an opening, door and/or window, and/or (b) a wall segment of the walls has permanent fixtures attached thereto, and wherein the outer tiers are configured to offset an additional distance from wall outlines indicated in the inner tiers.

15. The medium of claim 12, wherein the generated architectural annotations further includes tags, wherein the dimensions are configured to be offset by a predetermined measurement range from wall outlines of the walls and wherein the tags for the walls are rendered outside of the dimensions and/or wall elevations.

16. The medium of claim 9, further comprising generating architectural annotations for each of the extracted key data items and generating isometric projections of interior rooms as part of the drawings, the generated architectural annotations comprising one or more of a label, identification tags, and dimensions,
updating the rendered two dimensional floorplan with the generated architectural annotations, and
rendering edges and lines of varying line-weight and/or opacity to provide depth.

17. The medium of claim 16, wherein the generated architectural annotations includes dynamic tags that maintain consistent sizing with scaled floor plans and wall elevations of the two dimensional floorplan, and wherein the tags for the walls, windows, and/or doors are rendered relative to a predefined center-point on the extracted key data items.

18. The medium of claim 1, wherein the description data is generated via at least one of a camera, a user interface, an environment sensor, and an external location information database, the description data comprising one or more images of the physical scene.

19. The medium of claim 1, wherein the description data comprises one or more media types, the one or more media types comprising at least one or more of video data, image data, audio data, text data, user interface/display data, and/or sensor data, and wherein receiving description data comprises receiving one or more images from a camera and/or sensor data from one or more environment sensors, the one or more environment sensors comprising at least one of a GPS, an accelerometer, a gyroscope, a barometer, or a microphone.

20. The medium of claim 1, wherein the three dimensional representation comprises a textured or untextured three-dimensional mesh with vertices connected by edges, defining triangular or quadrilateral planar faces.

21. The medium of claim 1, wherein the three dimensional representation of the physical scene is stored as a triangle mesh, which comprises a graph data structure storing lists of vertices and a list of indices that indicate which vertices are joined together as a triangle, with each vertex comprising attributes including a position, a color, a normal vector, a parametrization coordinate, an instance index and a semantic class index; and wherein generating the three dimensional representation of the physical scene based on the description data comprises transferring detections of physical scene structures indicated by the data items to the three dimensional representation by:
predicting, with the trained machine learning model, semantic classes for two dimensional input video frames included in the description data,
projecting mesh vertices onto a camera image plane to map each of the mesh's vertices to image coordinates and determine a predicted label;
determining whether a projected mesh vertex falls into a region labeled as a floor, wall, or ceiling; and
determining a per mesh triangle label, where a triangle is labeled as part of the floor, wall, or ceiling if all of its adjacent vertices are labeled as floor, wall, or ceiling.

22. The medium of claim 1, the operations further comprising extracting the data items by providing the description data as input to the trained machine learning model to identify the data items, wherein the trained machine learning model comprises a convolutional neural network (CNN) and is trained to identify objects and structures in multiple physical scenes as the data items.

23. The medium of claim 1, wherein the machine learning model is trained with training data comprising input output training pairs associated with each potential data item, the training comprising:
obtaining physical scene data associated with a specified physical scene at the location, wherein the physical scene data includes an image, a video or a three dimensional digital model associated with the specified physical scene; and
training the machine learning model with the physical scene data to predict a specified set of surfaces and/or contents in the specified physical scene such that a cost function that is indicative of a difference between a reference set of surfaces and/or contents and the specified set of contents is minimized,
wherein the trained machine learning model is configured to predict spatial localization data of the data items, the spatial localization data corresponding to location information of the surfaces and/or contents in the physical scene.

24. The medium of claim 1, the operations further comprising determining attributes of the data items with the trained machine learning model, the attributes comprising dimensions and/or locations of the surfaces and/or contents.

25. The medium of claim 1, the operations further comprising determining point to point measurements in the three dimensional representation, determining area measurements of one or more data items, and/or receiving user annotations related to one or more of the data items, and generating the one or more isometric and/or orthographic vector drawings based on the point to point measurements, the area measurements, and/or the user annotations.

26. (canceled)

27. (canceled)
